(19) United States
(12) Patent Application Publication
(10) Pub. No.: US 2026/0352327 A1
(43) Pub. Date: Nov. 5, 2026

(54) COMMUNICATION SYSTEM AND NORMALCY JUDGMENT METHOD

(71) Applicant: NTT, Inc., Tokyo (JP)

(72) Inventor: Manabu YOSHINO, Musashino-shi (JP)

(73) Assignee: NTT, Inc., Tokyo (JP)

(21) Appl. No.: 19/099,871

(22) PCT Filed: Aug. 4, 2022
(86) PCT No.: PCT/JP2022/029937

§ 371 Date: Jan. 30, 2025

(51) Int. Cl. H04B 10/077

(52) U.S. Cl. CPC H04B 10/0775

(57) ABSTRACT

A communication system is a communication system comprising one or more control apparatuses and one or more user apparatuses, a first user apparatus or first control apparatus responds with a second control signal to a first control signal transmitted from a second user apparatus or second control apparatus, and the second user apparatus or second control apparatus determines whether a signal path including sections between the first user apparatus or first control apparatus and the second user apparatus or second control apparatus is normal, on the basis of the second control signal used in the response. The first user apparatus or the first control apparatus may loop back the first control signal transmitted from the second user apparatus or second control apparatus, and the second user apparatus or second control apparatus may determine whether the signal path including sections between the first user apparatus or first control apparatus and the second user apparatus or second control apparatus is normal, on the basis of the looped back first control signal.

### TECHNICAL FIELD

The present invention relates to a communication system and a normalcy judgment method.

### BACKGROUND ART

With the spread of the Internet of Things (IOT) and the progress of digitalization of society and industry, an amount of data flowing on the Internet is increasing. Additionally, service use cases of a type different from the best-effort type are emerging. Toward the advancement of such services, demands for guaranteed bandwidth and low latency are increasing for communication networks. For example, in a cyber-physical system, it is necessary to upload a huge amount of sensing data obtained from a real world (physical space) to an information processing infrastructure (cyber space) in real time without loss, to feed back control information to the real world with high reliability and low delay, and transfer high-definition images, in a transport infrastructure. The cyber-physical system is a system in which a huge amount of sensing data obtained from the real world is analyzed on a computer, and an analysis result is fed back to realize optimal control of the real world. It is expected that such a cyber-physical system will create new values and solutions.

An all-photonics network (APN) based on a photonics technology is being considered as a new architectural network for accommodating traffic that requires large capacity and low latency on the basis of these (See Non Patent Document 1). The APN is one of transparent networks that transmit arbitrary user signals. The APN provides an end-to-end optical path, independent of a specific communication protocol and optical modulation scheme.

### CITATION LIST

### Non Patent Document

Non Patent Document 1: Shin Kaneko, Kazuki Hara, Junichi Kani, Tsuyoshi Seki, Mitsutaka Kawahara, Takashi Miyamura, Hideki Maeda, “Special feature 2-10 2. Further evolution of ICT to support a super smart society: New system architecture for realization of All-Photonics Network”, Journal of the Institute of Electronics, Information and Communication Engineers, Vol. 104, No. 5, pp. 471-477, May 2021

### SUMMARY OF INVENTION

### Technical Problem

However, a method of determining the normality (transmission confirmation) of optical signal paths that transparently transmit main signals of various protocols in an APN has not yet been established. Hereinafter, determining the normality of the optical signal path will be referred to as “signal path normality determination”. For example, when a communication error occurs, the optical signal transmission path is divided, and the signal path normality determination (normality monitoring) is performed for each divided section in order to identify a location where the error has occurred. In the signal path normality determination for each section, transmission of the optical signal is confirmed from one side to the other side of a signal path normality determination target section. Here, the transmission confirmation is performed by performing optical-electrical conversion (hereinafter referred to as “OE conversion”) of at least a part of the optical signal at the end point of the signal path normality determination target section, and performing a termination and determination or performing a determination using, for example, nonlinear optical effects regarding the optical signal. Here, the use of nonlinear optical effects, or the like refers to use of change in the gain, current, or voltage of the gain medium or the light absorption medium, use of change in passing-through intensities of the pump or gain-clamp lights passed-through the gain medium or the light absorption medium, or use of change in light generated by nonlinear optical effects such as idler lights. In the signal path normality determination, a loopback method in which a response is looped back from the other target section in response to a request from one of the target sections is mainly used. In optical signal loopback, an OE conversion for transmitting a requested optical signal to one end point or an end thereof of an optical signal path normality determination target section and receiving a response, and optical-electrical-optical conversion (hereinafter referred to as “OEO conversion”) is required at a turning point of the optical signal where a response to the request at the other end point or an end thereof is looped back. Unlike a network of the related art, in a transparent network, there is not necessarily an apparatus that performs photoelectric conversion and termination according to the protocol of the main signal depending on the user apparatus for each normality determination section. When each section is terminated with such an apparatus, the network will no longer be transparent.

FIG. 16 is a diagram showing an example of a frequency of the control signal and a frequency of the main signal (user signal). In FIG. 16, the control signal is an Auxiliary Management and Control Channel (AMCC) signal. In the APN, a photonic gateway in a station (hereinafter referred to as a “Ph-GW”) transmits an AMCC signal whose frequency is superimposed on the main signal to the user apparatus and other apparatuses constituting a network such as a Ph-GW. A user apparatus or another apparatus constituting a network such as a Ph-GW may transmit an AMCC signal whose frequency is superimposed on the main signal to another user apparatus or an apparatus constituting the network such as a Ph-GW. The apparatus constituting the network, such as a user apparatus and a Ph-GW may receive the AMCC signal.

In view of the above circumstances, an object of the present invention is to provide a communication system and a normality determination method capable of determining the normality of a signal path in a transparent network.

### Solution to Problem

An aspect of the present invention is a communication system including one or more control apparatuses and one or more user apparatuses, wherein a first user apparatus or first control apparatus responds with a second control signal to a first control signal transmitted from an opposing second user apparatus or second control apparatus, the second user apparatus or second control apparatus determining whether a signal path including sections between the first user apparatus or first control apparatus and the second user apparatus or second control apparatus is normal on the basis of the second control signal used in the response, or the first user apparatus or first control apparatus loops back the first control signal transmitted from the opposing second user apparatus or second control apparatus, and the second user apparatus or second control apparatus determines whether a signal path including the section between the first user apparatus or first control apparatus and the second user apparatus or second control apparatus is normal on the basis of the looped back first control signal.

An aspect of the present invention is a communication system including one or more control apparatuses and one or more user apparatuses, wherein a first user apparatus or first control apparatus loops back a first main signal transmitted from a second user apparatus or second control apparatus that generates and terminates a main signal in a signal format selected on the basis of a signal format used by an opposing second user apparatus or second control apparatus, the second user apparatus or second control apparatus determines whether a signal path including sections between the second user apparatus or second control apparatus and the first user apparatus or first control apparatus is normal on the basis of the looped back first main signal, or the first user apparatus or first control apparatus loops back a second main signal transmitted from the second server apparatus or second control apparatus in a signal format selected on the basis of a signal format used by the opposing second user apparatus or second control apparatus, the second user apparatus or second control apparatus determines whether a signal path including sections between the second user apparatus or second control apparatus and the first user apparatus or first control apparatus is normal on the basis of the looped back second main signal, or the first user apparatus or first control apparatus responds with a third main signal to the first main signal transmitted from the second user apparatus or second control apparatus that generates and terminates the main signal in the signal format selected on the basis of the signal format used by the opposing second user apparatus or second control apparatus, the second user apparatus or second control apparatus determines whether a signal path including a section between the second user apparatus or second control apparatus and the first user apparatus or first control apparatus is normal on the basis of the third main signal used in the response, or the first user apparatus or first control apparatus responds with a fourth main signal to the second main signal transmitted from the opposing second user apparatus or second control apparatus in the signal format selected on the basis of the signal format used by the opposing second user apparatus or second control apparatus, and the second user apparatus or second control apparatus determines whether a signal path including sections between the second user apparatus or second control apparatus and the first user apparatus or first control apparatus is normal on the basis of the fourth main signal used in the response.

An aspect of the present invention is a normality determination method executed by a communication system including one or more control apparatuses and one or more user apparatuses, the normality determination method including: a first user apparatus or first control apparatus responds with a second control signal to a first control signal transmitted from a second user apparatus or second control apparatus, the second user apparatus or second control apparatus determining whether a signal path including sections between the first user apparatus or first control apparatus and the second user apparatus or second control apparatus is normal on the basis of the second control signal used in the response, or the first user apparatus or first control apparatus loops back the first control signal transmitted from the second user apparatus or second control apparatus, and the second user apparatus or second control apparatus determines whether the signal path including the section between the first user apparatus or first control apparatus and the second user apparatus or second control apparatus is normal on the basis of the looped back first control signal.

An aspect of the present invention is a communication system including a first control apparatus, a second control apparatus, a first user apparatus, and a second user apparatus, wherein the first control apparatus transmits a first control signal for instructing loopback to the first user apparatus, the second control apparatus transmits a second control signal for instructing the loopback to the second user apparatus, the second user apparatus loops back a main signal transmitted from the first user apparatus, and the first user apparatus determines whether a signal path including a section between the first user apparatus and the second user apparatus is normal on the basis of the looped back main signal.

An aspect of the present invention is a communication system including a first user apparatus and a second user apparatus, wherein the second user apparatus transmits an instruction signal indicating a loopback instruction to the first user apparatus, and loops back a control signal transmitted from the first user apparatus, and the first user apparatus transmits an instruction signal indicating the loopback instruction to the second user apparatus, and determines whether a signal path including a section between the first user apparatus and the second user apparatus is normal on the basis of the looped back control signal.

### Advantageous Effects of Invention

With the present invention, it is possible to determine the normality of a signal path in a transparent network.

### BRIEF DESCRIPTION OF DRAWINGS

FIG. 1 A diagram showing a configuration example of a communication system in the present embodiment.

FIG. 2 A diagram showing a first example of a configuration of a communication system in a first embodiment.

FIG. 3 A diagram showing a second example of the configuration of a communication system in the first embodiment.

FIG. 4 A diagram showing a third example of the configuration of a communication system in the first embodiment.

FIG. 5 A diagram showing a fourth example of the configuration of a communication system in the first embodiment.

FIG. 6 A diagram showing a first example of a configuration of a communication system in a second embodiment.

FIG. 7 A diagram showing a second example of the configuration of the communication system in the second embodiment.

FIG. 8 A diagram showing a third example of the configuration of the communication system in the second embodiment.

FIG. 9 A diagram showing a configuration example of a communication system in a third embodiment.

FIG. 10 A diagram showing a first example of a configuration of a communication system in a fourth embodiment.

FIG. 11 A diagram showing a second example of the configuration of the communication system in the fourth

FIG. 12 A diagram showing an example of a configuration of a communication system in a fifth embodiment.

FIG. 13 A diagram showing an example of a configuration of a communication system in a sixth embodiment.

FIG. 14 A diagram showing a modification example of a configuration example of the communication system in the sixth embodiment.

FIG. 15 A diagram showing an example of a hardware configuration of a communication system.

FIG. 16 A diagram showing an example of a frequency of a control signal and a frequency of the main signal (user signal).

### DESCRIPTION OF EMBODIMENTS

### Basic Configuration Example of APN

Since an APN uses a flat architecture, there is no need for an electrical termination for optical signals provided between the layers in communication networks as a comparative example with the APN. The APN has very low latency due to an end-to-end optical path connection. Further, an APN has high flexibility and expandability, allowing a high-capacity, low-latency communication network to be simply provided for each of functions without relying on a specific communication protocol.

The APN includes two types of optical nodes including a photonic gateway (Ph-GW) and a photonic exchange (hereinafter referred to as “Ph-EX”), which minimize electrical processing such as exchange, multiplexing, and switching (Ph-GW is connected to the full mesh). Ph-GW is an optical node located at the entrance of a full mesh network and accommodates various user apparatus. The full mesh is a connection form in which all elements constituting a communication network are directly connected to each other. Ph-EX is an optical node that provides a huge number of optical paths. The vast number of optical paths transparently traverse an optical backbone network. Ph-EX connects optical networks to which different optical multiplexing schemes have been applied, by converting the optical multiplexing scheme.

With such a configuration, the APN can directly connect arbitrary points (installation points of the user apparatuses) using optical signals without performing electrical processing. High-capacity and low-latency communication can be realized through allocation of dedicated wavelengths to user services. In the APN, it is possible to provide a variety of services by flexibly combining necessary service function processing at required points. Furthermore, the APN can provide a communication environment that does not require consideration of service types, protocols, optical wavelengths, or the like

In order to realize end-to-end optical direct connection and service function processing at required points, Ph-GW has five basic functions illustrated below.

The first basic function is a function of determining which wavelength the user apparatus uses and remotely setting wavelength information in the user apparatus. In order to open an end-to-end optical path, a function of assigning wavelengths to each optical path not to cause duplication of wavelengths of optical signals between optical paths sharing a transmission medium (optical fiber or the like) in an APN is required for Ph-GW. Furthermore, the Ph-GW is required to have a function of remotely setting the wavelength information of the optical signal of the user apparatus, which is the end point of the optical path.

The second basic function is a function of stopping unnecessary signals caused by misconfiguration of wavelength information to the user apparatus by communicating an optical signal between an access network side port and a full mesh network side port according to opening of the optical path. Here, the access network is a network between the Ph-GW and the user apparatus, and the full mesh network is a network between the Ph-GWs or a network consisting of Ph-GWs and Ph-EXs. Depending on destinations, Ph-GW transfers (cross-connects) optical signals input from the access network to the access network, optical signals input from the access network to the full mesh network, optical signals input from the full mesh network to the access network, and optical signals input from the full mesh network to the full mesh network as light itself.

A third basic function is a function of aggregating and disaggregating optical paths that share a transmission medium within a full mesh network.

The fourth basic function is a turn-back function for directly optically connecting user apparatuses accommodated in the same Ph-GW. Enabling turn-back at the Ph-GW located at the entrance of the full mesh network, rather than turn-back at the upper optical node realizes direct optical connection through the shortest route.

The fifth basic function is an extraction and insertion function. The extraction and insertion functions enable electrical processing at the Ph-GW location in order to perform regenerative relay of optical signals in terms of optical signal transmission and to perform service function processing.

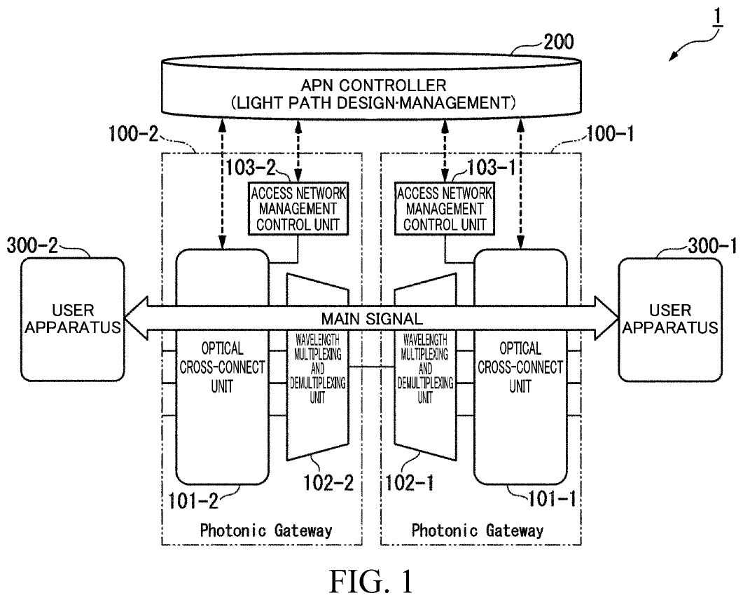

FIG. 1 is a diagram showing a configuration example of a communication system 1 in each embodiment. The communication system 1 is a communication system that communicates using a transparent communication network such as an all-photonics network (APN). The communication system 1 transmits an optical signal from an apparatus at one end of the section that is a determination target, photoelectrically converts the received signal at the apparatus at the other end, converts the received signal or a response according to the received signal from an electrical signal to light, transmits the light, that is, performs OEO conversion to loop back the optical signal or control signal, performs OE conversion on the looped back optical signal or control signal on the transmitting side, and confirms the content of the signal, to thereby determine normality of the path for the optical signal in the section that is a determination target. The section that is a determination target may include areas between the user apparatus 300 and Ph-GW 100, between the Ph-GW 100 and Ph-GW 100, and between the user apparatus 300 and the user apparatus 300. In FIG. 1, the user apparatus 300 and the Ph-GW 100 are illustrated as apparatuses at ends of the section.

The communication system 1 includes a Ph-GW 100-1, a Ph-GW 100-2, an APN controller 200, a user apparatus 300-1, and a user apparatus 300-2. In order to simplify the description, in FIG. 1, two Ph-GWs and two user apparatuses are shown. In an actual communication system, it is assumed that a large number of Ph-GWs and the user apparatuses are disposed, and Ph-EX may be used between the Ph-GW and the user apparatus may be used only through a single Ph-GW.

The Ph-GW 100 is an apparatus (transmission and reception apparatus) that transmits and receives optical signals. The Ph-GW 100 transmits and receives optical signals for monitoring and controlling the user apparatus 300 and determining the normality of sections with the user apparatus or another Ph-GW 100. When the end point of the section does not reach the Ph-GW 100, the optical signal may pass through the Ph-GW 100.

Further, the Ph-GW 100 is an apparatus (cross-connect apparatus) that cross-connects optical signals to a destination. Ph-GW 100-1 includes an optical cross-connect unit 101-1, a wavelength multiplexing and demultiplexing unit 102-1, and an access network management control unit 103-1 (control apparatus). Ph-GW 100-2 includes an optical cross-connect unit 101-2, a wavelength multiplexing and demultiplexing unit 102-2, and an access network management control unit 103-2 (control apparatus). The optical cross-connect unit 101 includes a plurality of input and output ports (not shown). The wavelength multiplexing and demultiplexing unit 102-2 is not necessarily disposed on a path for a target optical signal.

The user apparatus 300-1 includes an optical transceiver 301-1 (optical TRx) (not shown). The user apparatus 300-2 includes an optical transceiver 301-2 (optical TRx) (not shown).

The optical cross-connect unit 101-1 and the optical cross-connect unit 101-2 transfer (cross-connect) optical signals input from the access network and the full mesh network as light itself according to the destination. Thereby, the optical cross-connect unit 101-1 and the optical cross-connect unit 101-2 realize the function of turning back for direct optical connection (the fourth basic function).

The optical cross-connect unit 101-1 and the optical cross-connect unit 101-2 realize a loopback function (the fourth basic function described above) for directly optically connecting the user apparatuses 300 accommodated in the same Ph-GW 100. Furthermore, the optical cross-connect unit 101-1 and the optical cross-connect unit 101-2 realize optical add/drop (the fifth basic function) to the electrical processing unit (not shown).

The wavelength multiplexing and demultiplexing unit 102-1 wavelength-multiplexes optical signals that share the same path among the optical signals output from the optical cross-connect unit 101-1. The wavelength multiplexing and demultiplexing unit 102-1 outputs the wavelength-multiplexed optical signal to the full mesh network. The wavelength multiplexing and demultiplexing unit 102-1 demultiplexes the wavelength multiplexed signal input from the full mesh network in units of wavelengths.

The wavelength multiplexing and demultiplexing unit 102-2 wavelength-multiplexes optical signals having the same destination among the optical signals output from the optical cross-connect unit 101-2. The wavelength multiplexing and demultiplexing unit 102-2 outputs the wavelength-multiplexed optical signal to the full mesh network. The wavelength multiplexing and demultiplexing unit 102-2 demultiplexes the wavelength multiplexed signal input from the full mesh network in units of wavelengths (the third basic function).

In the Ph-GW 100, the access network management control unit 103-1, which is one of the apparatuses (transmission and reception apparatuses) included in the Ph-GW 100 that transmits and receives optical signals, exchanges control information between the control unit 103-1 and the user apparatus 300-1 at the time of initial connection of the user apparatus 300-1. The access network management control unit 103-1 transmits a wavelength setting instruction to the user apparatus 300-1.

The access network management control unit 103-2 exchanges control information between the access network management control unit 103-2 and the user apparatus 300-2 at the time of initial connection of the user apparatus 300-2. The access network management control unit 103-2 transmits the wavelength setting instruction to the user apparatus 300-2 (the first basic function).

Optical signals transmitted and received by the access network management control unit 103 (hereinafter referred to as “access system optical signals”) may be multiplexed and demultiplexed with the path to the user apparatus 300 at any point. For example, the access system optical signal may be multiplexed and demultiplexed in the wavelength multiplexing and demultiplexing unit 102, the access system optical signal may be multiplexed and demultiplexed between the wavelength multiplexing and demultiplexing unit 102 and the optical cross-connect unit 101, or the access system optical signal may be multiplexed and demultiplexed between the optical cross-connect unit 101 and the user apparatus 300.

Instead of multiplexing the access system optical signal through, for example, space division multiplexing, polarization division multiplexing, or wavelength division multiplexing with the optical signal of the main signal, the access network management control unit 103 may multiplex the control signal on the optical signal of the main signal in the form of time division multiplexing, code division multiplexing, or frequency division multiplexing such as AMCC, or may multiplex the control signal on the optical signal of the main signal in the form of intensity modulation, phase modulation, frequency modulation, or polarization modulation. In this case, the multiplexing may be performed by using a modulator, an amplifier or attenuator that can modulate an amplification factor or attenuation factor instead of multiplexing being performed using a coupler/splitter, a multiplexer/demultiplexer, or the like. Description will mainly be given hereinafter in the form of multiplexing the control signal onto the optical signal of the main signal, but it is clear that this can also be used to multiplex an access system optical signal that is separate from the optical signal of the main signal. When the access system optical signal is multiplexed on the loopback side and an optical transmission unit or optical reception unit for the access system optical signal and the main signal are separate, an optical transmission unit or optical reception unit for the main signal deviates from the normality determination, and thus, in order to determine the normality of the section outside the normality determination, it is desirable to perform loopback between the optical transmission unit and the optical reception unit, or determine the normality by a means other than the loopback. In addition, with these schemes, when the loopback signal is looped back from the optical transmission unit of the access system optical signal only when the normality of the optical transmission unit and the optical reception unit of the main signal is determined, it is possible to notify the normality of the optical transmission unit or optical reception unit for the main signal through single loopback. Of course, the normality of the optical transmission unit or optical reception unit for the main signal, the optical transmission unit or optical reception unit for the access system optical signal, or the like may be separately determined and notified of.

APNs that support a variety of social infrastructure networks are required to be able to set optical paths for a variety of user apparatuses so that dedicated networks with wavelengths for different functions can be easily provided. Therefore, a mechanism in which an optical path is immediately passed just by the user apparatus 300-1 and the user apparatus 300-2 being connected to the optical fiber is required.

First, the user apparatus 300-1 or the user apparatus 300-2 reports the host apparatus information and opposing apparatus information to the nearest Ph-GW 100, for example. The user apparatus 300-1 or user apparatus 300-2 may report the host apparatus information and opposing apparatus information to the Ph-GW 100-1 or Ph-GW 100-2. Although reporting to the most recent Ph-GW 100 is performed, reporting to the Ph-GW 100 other than the most recent Ph-GW 100 may be performed. For example, the user apparatus 300-1 or user apparatus 300-2 may report host apparatus information and opposing apparatus information to the Ph-GW 100-2 or Ph-GW 100-1. The latter is suitable, for example, in a case in which information on the PhGW to which the opposing apparatus is connected is known when a connection is restored, for example. Hereinafter, a case where the most recent report is performed will be mainly described.

Second, the APN controller 200 executes wavelength resource management and optical path design within the APN. In response to the report from the user apparatus 300-1 or the user apparatus 300-2, the Ph-GW 100-1 or Ph-GW 100-2 cooperates with the APN controller 200 to determine an allocated wavelength for the user apparatus 300-1 or the user apparatus 300-2. Ph-GW 100-1 or Ph-GW 100-2 notifies the user apparatus 300-1 or the user apparatus 300-2 of the wavelength.

Third, an internal route of Ph-GW 100-1, an internal route of Ph-GW 100-2, and an internal route of Ph-EX are each set. In FIG. 1, the internal route of Ph-GW 100-1, the internal route of Ph-GW 100-2, and the route connecting Ph-GW 100-1 and Ph-GW 100-2 are set. When the Ph-GW 100-1 and the Ph-GW 100-2 are connected via Ph-EX (not shown), an internal route of the Ph-GW 100-1, an internal route of the Ph-GW 100-1 and Ph-EX (not shown), an internal route of Ph-EX (not shown), an internal route of Ph-EX (not shown) and Ph-GW 100-2, and an internal route of the Ph-GW 100-2 are set.

In the APN, optical signals according to signals of various communication protocols are transmitted from the user apparatus 300-1 and the user apparatus 300-2. Therefore, a management control scheme that does not depend on the communication protocol is required. For example, AMCC is used for such access system management control. In the communication system 1, the user apparatus 300-1 communicates via the Ph-GW 100 within the station.

### First Embodiment

### Main Signal Loopback

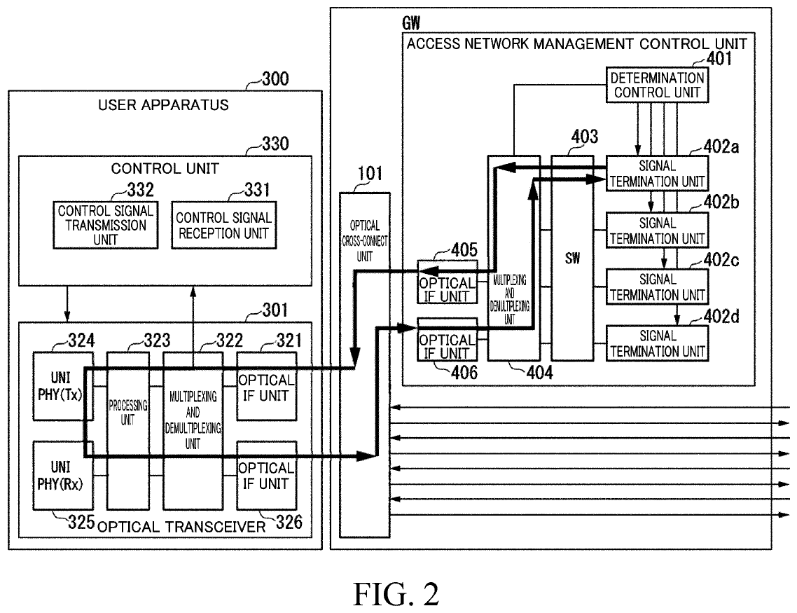

In each of FIGS. 2 to 5, the present embodiment is a communication system including an apparatus that transmits and receives optical signals, wherein one opposing apparatus selectively generates an optical signal in a format (a protocol, a modulation scheme, a modulation rate, a code format) (a form of the main signal known in advance) that can be transmitted and received by the other opposing apparatus, and transmits the generated optical signal to the other opposing apparatus. This is a communication system in which the other opposing apparatus loops back and transmits the received optical signal or a response thereto, and the one opposing apparatus receives the looped back optical signal or the response thereto (in a format that can be transmitted and received by the other opposing apparatus), and determines whether a signal path including a signal path between the one opposing apparatus and the other opposing apparatus is normal on the basis of the received looped back optical signal or the response thereto.

Hereinafter, selecting an optical signal in a reception possibility format will be referred to as “format selection”. Hereinafter, generating and transmitting a signal, receiving and terminating the looped back signal will be referred to as “generation, transmission, reception, and termination.”

In each of FIGS. 2 to 5, an example in which one apparatus (the apparatus that selects and processes the signal format used by the opposing apparatus) is Ph-GW, and the other apparatus (the apparatus that processes the signal format of the host apparatus) is the user apparatus is shown. That is, a system configuration pattern of “format selection+generation, transmission, reception, and termination side: Ph-GW” and “loopback side: user apparatus” is shown.

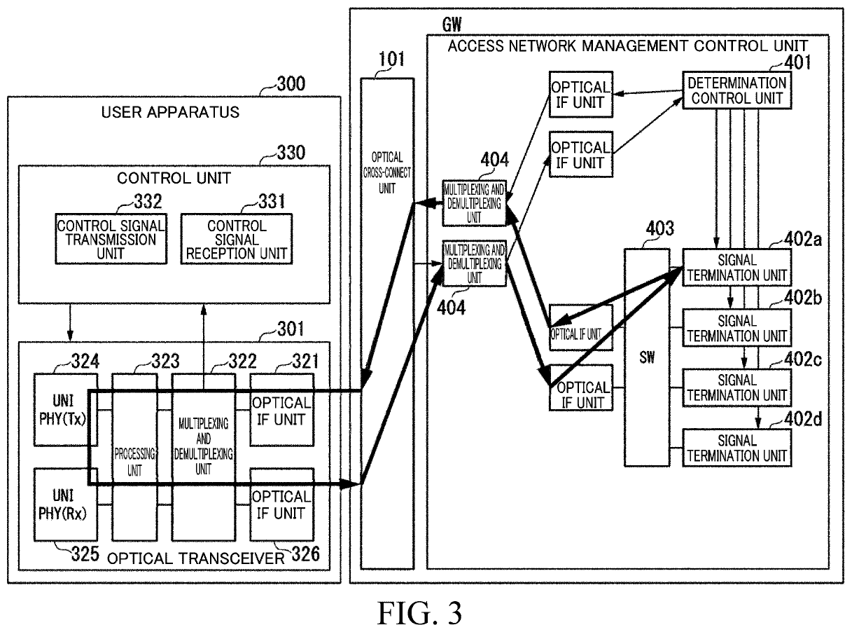

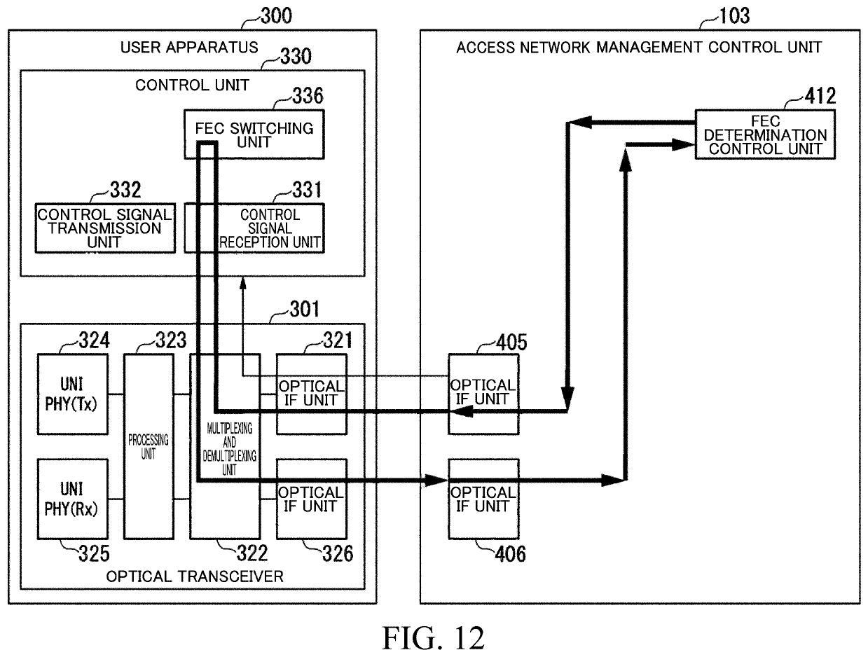

FIG. 2 is a diagram showing a first example of the configuration of a communication system in the first embodiment. The access network management control unit 103 includes a determination control unit 401, a plurality of the signal termination units 402 (for example, signal termination units 402a to 402d) corresponding to the optical signal in a format (a protocol, a modulation scheme, a modulation rate, a code format) (a form of the main signal known in advance) that can be transmitted and received by the other opposing apparatus, a SW 403, a multiplexing and demultiplexing unit 404, an optical interface unit (optical IF unit) 405, and an optical interface unit (optical IF unit) 406. The determination control unit 401 is a functional unit that determines the normality of the transmission section. The determination control unit 401 instructs the selected signal termination unit 402 to transmit the main signal to the target user apparatus. A bold arrow indicates the route of the main signal that is looped back. In FIG. 2, the multiplexing and demultiplexing unit 404 multiplexes and demultiplexes the control signal onto the main signal selected by the SW 403 at an electrical stage. A bold line arrow in FIG. 2 corresponds to “format selection +generation, transmission, reception, and termination side: Ph-GW” and “loopback side: user apparatus”. “Format selection +loopback side: Ph-GW” and “generation, transmission, reception, termination side: user apparatus route” may be used. This also applies to FIGS. 3 to 9, which will be described later, and FIGS. 12 to 14, which will be described later.

FIG. 3 is a diagram showing a second example of the configuration of the communication system in the first embodiment. The access network management control unit 103 includes a determination control unit 401, a plurality of the signal termination units 402 (for example, signal termination units 402a to 402d) corresponding to the optical signal in a format (a protocol, a modulation scheme, a modulation rate, a code format) (a form of the main signal known in advance) that can be transmitted and received by the other opposing apparatus, a SW 403, a plurality of (for example, two) multiplexing and demultiplexing unit 404, and a plurality of (for example, four) optical interface units (optical IF units). A bold arrow indicates the route of the main signal that is looped back. In FIG. 3, the multiplexing and demultiplexing unit 404 multiplexes and demultiplexes the control signal on the main signal selected by the SW 403 at an optical stage.

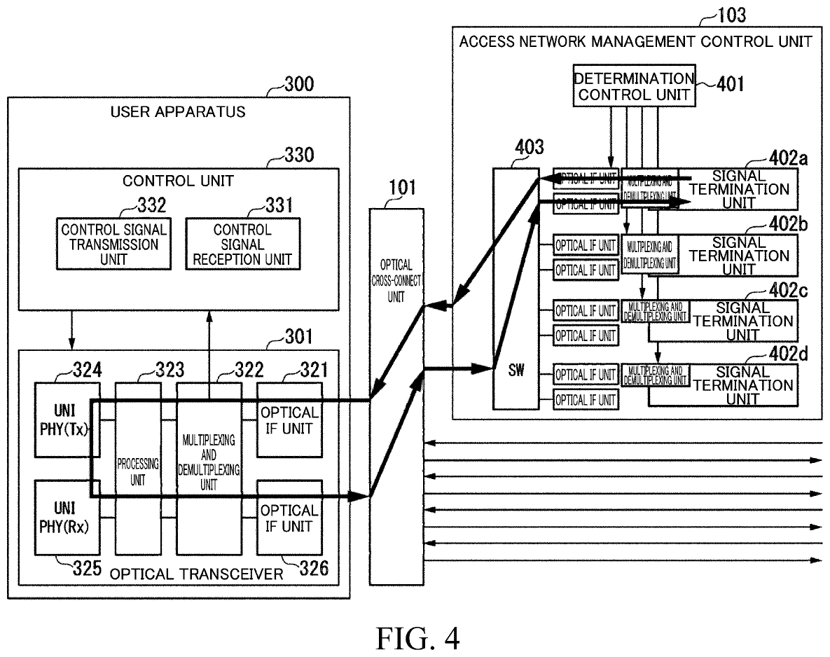

FIG. 4 is a diagram showing a third example of the configuration of the communication system in the first embodiment. The access network management control unit 103 includes a determination control unit 401, a plurality of signal termination units 402 (for example, 402a to 402d), a SW 403, a plurality of (for example, four) multiplexing and demultiplexing units, and a plurality of (for example, eight) optical interface units (optical IF units) corresponding to the optical signal in a format (a protocol, a modulation scheme, a modulation rate, a code format) (a form of the main signal known in advance) that can be transmitted and received by the other opposing apparatus. A bold arrow indicates the route of the main signal that is looped back. In FIG. 4, the SW 403 selects the optical signal obtained by multiplexing and demultiplexing the control signal and the main signal at the electrical stage of the multiplexing and demultiplexing unit.

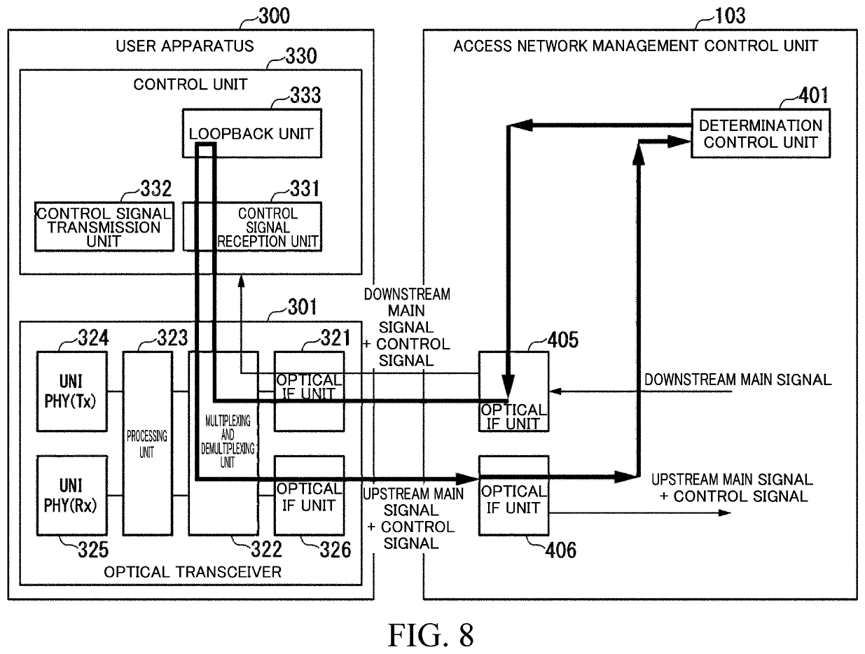

In FIGS. 2 and 4, control signals are multiplexed and demultiplexed at the electrical stage. In FIG. 2, an order from the signal termination unit to the user apparatus may be an order of the SW 403, the optical IF unit, and the multiplexing and demultiplexing unit, or an order of the optical IF unit, the SW 403, and the multiplexing and demultiplexing unit for each signal termination unit 402, instead of the order of the SW 403, the multiplexing and demultiplexing unit, and the optical IF unit. In FIG. 4, the order from the signal termination unit to the user apparatus may be an order of the optical IF unit, the multiplexing and demultiplexing unit, and the SW, and an order of the optical IF unit, the SW, and the multiplexing and demultiplexing unit, instead of an order of the multiplexing and demultiplexing unit 404, the optical IF unit, and the SW. The multiplexing and demultiplexing unit may be a modulation unit, and a reception unit that receives at least part of the signal, as shown in FIG. 8 which will be described later. FIGS. 2 and 4 show a configuration of a system that multiplexes and demultiplexes the control signal into the main signal using frequency division multiplexing or time division multiplexing in the electrical stage.

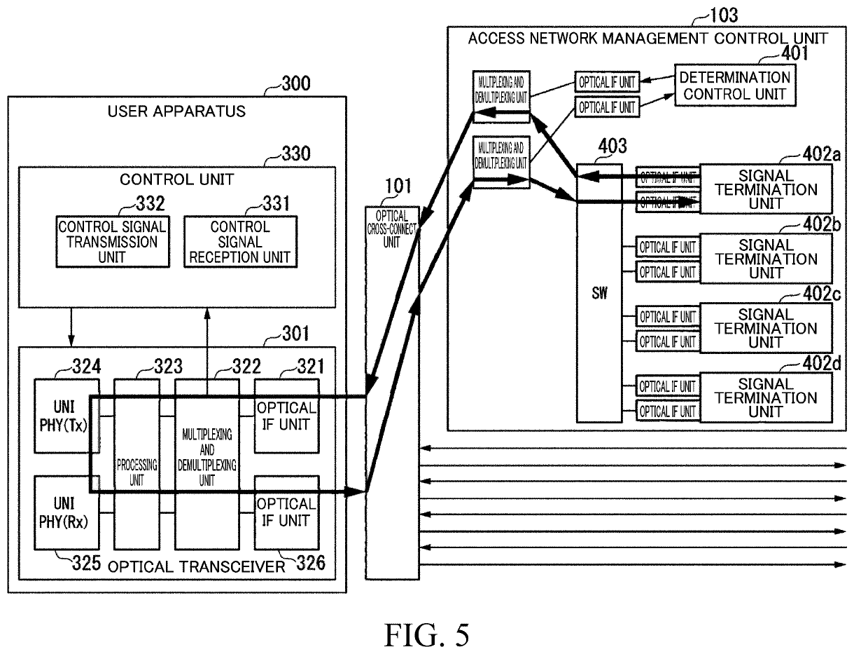

FIG. 5 is a diagram showing a fourth example of the configuration of the communication system in the first embodiment. The access network management control unit 103 includes a determination control unit 401, a plurality of signal termination units 402 (for example, 402a to 402d), a SW 403, a plurality of (for example, two) multiplexing and demultiplexing units, and a plurality of (for example, 10) optical interface units (optical IF units) corresponding to the optical signal in a format (a protocol, a modulation scheme, a modulation rate, a code format) (a form of the main signal known in advance) that can be transmitted and received by the other opposing apparatus. A bold arrow indicates the route of the main signal that is looped back. In FIG. 5, a multiplexing and demultiplexing unit multiplexes and demultiplexes a control signal on the main signal selected by the SW 403 at the optical stage. FIGS. 3 and 5 show, for example, a configuration of a communication system in which the control signal is multiplexed with and demultiplexed into the main signal at an optical stage through wavelength division multiplexing with an optical signal for a control signal with a different wavelength so that beat noise with the main signal can be ignored, polarization division multiplexing with an optical signal for different control signals whose polarizations capable of polarization separation with the main signal so that polarization fluctuation of the main signal can be ignored are orthogonal to each other, or the like.

FIGS. 2 to 5 are diagrams showing the communication system 1 of the first embodiment. In FIGS. 2 to 5, among the apparatuses included in the communication system 1, only the apparatus regarding one section that is the signal path normality determination target is shown. In the first embodiment, the access network management control unit 103 performs the signal path normality determination for the user apparatus 300 connected to the host apparatus (Ph-GW 100). For example, the access network management control unit 103-2 or 103-1 in FIG. 1 performs the signal path normality determination for a section with the user apparatus 300-2.

Depending on a determination section and direction, the user apparatus 300-2 performs the signal path normality determination on the access network management control unit 103-2, the access network management control unit 103-1, and the user apparatus 300-1. Further, the access network management control unit 103-2 or the access network management control unit 103-1 may perform the signal path normality determination for a section with the user apparatus 300-1, the access network management control unit 103-2 may perform the determination for a section with the access network management control unit 103-1, or the access network management control unit 103-1 may perform the determination for a section with the access network management control unit 103-2. However, in the first embodiment, since a main signal generation termination functional unit (signal format or format) is selected according to the main signal format of the opposing apparatus, it is desirable to select a format conforming to the format of the main signal used by the user apparatus using the route even when access network management control units perform the determination.

In the first embodiment, at the time of communication using the main signal (that is, excluding initial connection, monitoring, or the like), the main signal generation termination unit (the signal termination unit) according to the protocol used by the user apparatus 300 is included in Ph-GW, which is a relay apparatus that only cross-connects light without terminating the optical signal. When an end point of the section for a normality determination in the present embodiment is installed in Ph-EX that is a relay apparatus which does not terminate the main signal, as in Ph-GW, a main signal generation termination unit (the signal termination unit) is included in the relay apparatus such as Ph-EX.

(A1) The user apparatus loops back, and a system configuration pattern of a plurality of main signal termination units on the Ph-GW side (“format selection +generation, transmission, reception, and termination side: apparatus on the Ph-GW side” and “loopback side: user apparatus”), the apparatus on the Ph-GW side selects the main signal termination unit according to the main signal used by the opposing apparatus (here, the user apparatus) as shown, the selected main signal termination unit generates a normality determination request using the main signal, the opposing apparatus (here, the user apparatus) transmits the response regarding the normality determination in response to the request, the selected main signal termination unit of the apparatus on the Ph-GW side terminates the received response, or the apparatus on the Ph-GW side selects the main signal termination unit according to the main signal used by the opposing apparatus (here, the user apparatus), the selected main signal termination unit generates a normality determination signal using the main signal, the opposing apparatus (here, the user apparatus) loops back and transmits the normality determination signal, and the selected main signal termination unit of the apparatus on the Ph-GW side terminates the received loopback (loopback signal).

The optical cross-connect unit and the like are set so that the access network management control unit and the user apparatus can communicate. The access network management control unit selects the termination unit of the main signal of the protocol according to the user apparatus. A detection unit (not shown) may be provided to detect the format of the main signal, and the selection may be made on the basis of the detection result, or selection may be made on the basis of a response to a request to the user apparatus or a value reported from the user apparatus, selection may be made on the basis of a value held at the time of a service contract, a service order, or a database, a media access control (MAC) address of the transceiver that is transmitting and receiving the main signal may be acquired, reported, or received from a database or the like and estimated from a manufacturer or product type according to the address.

The access network management control unit instructs the user apparatus to loop back the main signal (loopback instruction). The instruction may be a control signal or may be the main signal. In the case of the control signal, a termination unit (the signal termination unit) according to the user apparatus may be selected after an instruction. In the case of the main signal, the instruction is given after the selection because the instruction is made using the main signal.

The access network management control unit generates and transmits a downstream main signal for a normality determination using a protocol according to the user apparatus. When no instruction or the like is given by the control signal, the main signal may not be modulated with the control signal or the control signal may not be superimposed on the main signal. The user apparatus loops back the downstream main signal or a response thereto as the upstream main signal.

When there is no response, or the like to the control signal, it is not necessary to modulate the main signal with the control signal or to superimpose the control signal on the main signal. The looped back upstream main signal is received, terminated, and determined by the access network management control unit. The loopback of the main signal of the user apparatus is canceled with the passage of time or an instruction from the access network management control unit. The instruction at this time may be a control signal or may be the main signal.

Here, the protocol of the main signal transmitted and received by the user apparatus is selected by at least one of an instruction from the APN controller, an acquisition from information from the DB or the user apparatus, or reception of the main signal and a determination as to whether termination as a normal signal is possible. This also applies to description to be below.

(A2) The user apparatus loops back, and a system configuration pattern of a plurality of main signal termination units on the user apparatus side (“format selection+loopback side: user apparatus”and “generation, transmission, reception, and termination side: apparatus on the Ph-GW side”), the user apparatus selects the main signal termination unit according to the main signal used by the opposing apparatus (here, the apparatus on the Ph-GW side), the main signal termination unit of the opposing apparatus (here, the apparatus on the Ph-GW side) generates the normality determination request using the main signal, the main signal termination unit selected by the user apparatus transmits the response regarding the normality determination in response to the request, the main signal termination unit of the apparatus on the Ph-GW side terminates the received response, or the user apparatus selects the main signal termination unit according to the main signal used by the opposing apparatus (here, the apparatus on the Ph-GW side), the main signal termination unit of the opposing apparatus (here, the apparatus on the Ph-GW side) generates a normality determination signal using the main signal, the selected main signal termination unit of the user apparatus loops back and transmits the normality determination signal, and the main signal termination unit of the opposing apparatus (here, the apparatus on the Ph-GW side) terminates the received loopback (loopback signal) (not shown)

A main signal termination unit (the signal termination unit) corresponding to the signal format used by the opposing apparatus may be disposed in the user apparatus. The optical cross-connect unit and the like are set so that the access network management control unit and the user apparatus can communicate. The access network management control unit selects the main signal termination unit (signal termination unit) disposed in the user apparatus. The user apparatus loops back the main signal at the selected signal termination unit. The Ph-GW receives and terminates the looped back upstream main signal, and determines the normality.

As another connection, when a transmission unit (optical IF unit) that transmits an optical signal that is looped back by the opposing apparatus is disposed in the Ph-GW for a normality determination, a transmission unit (optical IF unit) may be disposed, in addition to an access network management control unit connected via the optical cross-connect unit. For example, a transmission unit (optical IF unit) may be disposed at a position where the optical signal can be output to the loopback apparatus, via the optical coupler/splitter or the optical multiplexer/demultiplexer installed outside the input port or output port to the optical cross-connect unit. For example, a transmission unit (optical IF unit) is disposed in a monitoring unit that monitors the optical intensity of optical signals on at least one of the input side and output side of the Ph-GW or exchanges control signals with the user apparatus. Instead of combined or multiplexed light being output through the optical coupler/splitter or the optical multiplexer/demultiplexer, light generated by an optical nonlinear effect of the light to be looped back may be output.

A monitor is used to monitor the optical intensity or wavelength of the main signal when the main signal is exchanged, perform insertion into the path for the main signal to determine whether there is any error, and extract and monitor a part at a coupler/splitter, multiplexer/demultiplexer, or the like, or insert the control signal and control the user apparatus. Instead of splitting a part of the main signal using the coupler/splitter, the multiplexer/demultiplexer, or the like or multiplexing the control signal with the main signal or the like, processing corresponding to light generation using, for example, nonlinear optical effects which will be described later, that is, change in gain in a gain medium or light absorption medium, current or voltage applied to these media, pump light input to the media, change in intensity of gain clamp light after passing through the medium, or change in light generated by, for example, a nonlinear optical effect of idler light or the like may also be used. These are not shown in FIG. 1.

When a reception unit (optical IF unit) that receives at least a part of the optical signal looped back by the opposing apparatus is disposed in the Ph-GW for a normality determination, a reception unit (optical IF unit) may be disposed in addition to the access network management control unit connected via the optical cross-connect unit. For example, a reception unit (optical IF unit) may be disposed at a position where the optical signal looped back from the loopback apparatus or at least a part of a component thereof can be input, via the optical coupler/splitter or the optical multiplexer/demultiplexer installed outside the input port or output port to the optical cross-connect unit. For example, a transmission unit (optical IF unit) is disposed in a monitoring unit that monitors the optical intensity of optical signals on at least one of the input side and output side of the Ph-GW or exchanges control signals with the user apparatus. Instead of split or demultiplexed light input through the optical coupler/splitter or the optical multiplexer/demultiplexer, light generated by, for example, an optical nonlinear effect of looped back light may be input.

When loopback is performed on the Ph-GW side, the signal received by the reception unit (optical IF unit) is looped back by the selected signal termination unit 402 and output from the transmission unit (optical IF unit).

Regarding the access network management control unit 103, the network side from the multiplexing and demultiplexing unit 404 loops back the main signal at the signal termination unit or generates and terminates the main signal. When the optical IF unit is common for the control signal and the main signal (FIGS. 2 and 4), the user side from the multiplexing and demultiplexing unit 404 is common, and thus, both are transmitted and received by the optical IF unit. When at least one of the transmission and reception of the optical IF unit is different for the control signal and the main signal (if both transmission and reception are different, as shown in FIGS. 3 and 5), different transmissions or receptions, or both, are performed in the optical IF unit that corresponds to the control signal or the main signal.

Regarding the user apparatus 300, the user side from the multiplexing and demultiplexing unit 322 loops back or generates and terminates the main signal at the UNI side.

When the optical IF unit is common for the control signal and the main signal, the network side from the multiplexing and demultiplexing unit 322 is common, and thus, both are transmitted and received by the optical IF unit. When at least one of the transmission and reception of the optical IF unit of the user apparatus is different between the control signal and the main signal (as in the access network management control unit in FIGS. 3 and 5), different transmission, reception, or both are performed by the optical IF unit corresponding to the control signal or the main signal.

In FIG. 2, the multiplexing and demultiplexing unit 404 multiplexes and demultiplexes the control signal onto the main signal selected by the Sw 403 at an electrical stage. In FIG. 3, the multiplexing and demultiplexing unit 404 multiplexes and demultiplexes the control signal on the main signal selected by the SW 403 at an optical stage. In FIG. 4, the SW 403 selects the optical signal obtained by multiplexing and demultiplexing the control signal and the main signal at the electrical stage of the multiplexing and demultiplexing unit. In FIG. 5, a multiplexing and demultiplexing unit multiplexes and demultiplexes a control signal on the main signal selected by the SW 403 at the optical stage.

The multiplexing and demultiplexing unit may be a modulation unit and a reception unit that receives at least part of the signal, as shown in FIG. 8, which will be described later.

The access network management control unit 103 transmits the main signal to the user apparatus 300 (hereinafter referred to as “target user apparatus”) connected to the section that is a signal path normality determination target. In transmission of the main signal, the access network management control unit 103 transmits the main signal of a protocol that can be processed by the target user apparatus. In order to realize such processing, the access network management control unit 103 includes the determination control unit 401, a plurality of the signal termination units 402 (for example, 402a to 402d) corresponding to the optical signal in a format (a protocol, a modulation scheme, a modulation rate, a code format) (a form of the main signal known in advance) that can be transmitted and received by the other opposing apparatus, a SW 403, a multiplexing and demultiplexing unit 404, an optical interface unit (optical IF unit) 405, and an optical interface unit (optical IF unit) 406.

In FIGS. 2 and 3, the optical IF unit terminates the light, and after photoelectric conversion, the control signal and the main signal are split at the electrical stage, the control signal is selectively output to the determination control unit, and the main signal is selectively output to the signal termination unit by the electrical SW, an output from the signal termination unit is selected by the electrical SW, superimposed on the control signal at the electrical stage, input to the optical IF unit, photoelectrically converted, and output as light. As shown in FIG. 4, without optical termination, the SW 403 (optical SW) selectively outputs the signal to the signal termination units each including an optical IF unit, and the optical output from the signal termination unit including the optical IF unit is sent to the optical switch selectively output the signal. The latter case is suitable when the requirements or configurations for the optical IF unit differ for each the signal termination unit. The requirements are, for example, conditions regarding line width, frequency stability, and transmission bandwidth. Specific examples of different configurations include, for example, direct detection and coherent detection using local light. Furthermore, the input to and output from the determination control unit may be a combination of those shown in FIGS. 2, 3, and 5, and may be a combination of electricity and light, or light and electricity. In FIGS. 2 and 4, multiplexing is performed in the electrical stage.

When instructing with a control signal, the determination control unit 401 outputs a control signal indicating execution of loopback to the multiplexing and demultiplexing unit 404. When the signal transmitted from the user apparatus 300 is received by the signal termination unit 402, the determination control unit 401 determines the normality of the route that is a determination target on the basis of the received signal. The signal from the Ph-GW may be determined by the user apparatus, and the Ph-GW may receive a determination result. The user apparatus may receive the looped back signal at the Ph-GW and make a determination. According to an instruction from the Ph-GW, the user apparatus may transmit a loopback signal, loop back at the Ph-GW, receive the looped back signal at the user apparatus, and make a determination, and the user apparatus may send a determination result to the Ph-GW using the control signal or the main signal. In the first embodiment, control information can also be exchanged using the main signal.

The signal termination unit 402 generates the main signal in a format (protocol, modulation scheme, modulation rate, and code format) (form of the main signal known in advance) that can be transmitted and received by the user apparatus, and outputs the main signal to the SW 403. The Ph-GW may be a unidirectional transmission side or transmit a loopback signal. In the former case, the user apparatus receives and terminates the main signal for a normality determination, determines the normality, and notifies the Ph-GW of a result of the determination using the control signal or the like. In the latter case, the user apparatus loops back the main signal for loopback from the Ph-GW to the Ph-GW, receives and terminates the looped-back signal at the Ph-GW, and determines the normality.

The signal termination unit 402 outputs information on reception of the main signal to the determination control unit 401. When the Ph-GW is a one-way reception side or receives a loopback signal, in the former case, the user apparatus generates and transmits the main signal for a normality determination to the Ph-GW according to an instruction from the Ph-GW, or the like, and the Ph-GW receives and terminates the main signal to determine the normality. In the latter case, the user apparatus loops back the main signal for loopback from the Ph-GW to the Ph-GW, receives and terminates the looped-back signal at the Ph-GW, and determines the normality. (The latter is a part of a case where the signal termination unit 402 described above generates and transmits the main signal according to a specific protocol that is possible in the user apparatus, and outputs the main signal to the SW 403.)

For example, when the signal termination unit 402 cannot receive the main signal that is supposed to be looped back even after a predetermined period of time has elapsed, the signal termination unit 402 outputs information indicating this to the determination control unit 401. Upon receiving the looped back main signal, the signal termination unit 402 outputs information on the received main signal (an example of information on reception of the main signal) to the determination control unit 401. The information on the main signal is information used for a determination of the normality of the route. More specifically, the information on the main signal is, for example, information indicating whether or not loopback has been performed correctly and as requested.

According to an instruction from the Ph-GW or the like, the user apparatus may generate and transmit the main signal according to a specific protocol that can be used by the user apparatus, and performs reception and termination at the Ph-GW to determine normality. According to an instruction from the Ph-GW, or the like, the user apparatus may generate and transmit the main signal according to a protocol with characteristics that can be used by the user apparatus, loop back at the Ph-GW, performs reception and termination at the user apparatus, determine the normality, and notify the Ph-GW or the like of the result using the control signal or the like.

The SW 403 outputs the main signal output from the signal termination unit 402 to the multiplexing and demultiplexing unit 404. The SW 403 outputs the main signal output from multiplexing and demultiplexing unit 404 to the signal termination unit 402 according to the main signal.

The multiplexing and demultiplexing unit 404 superimposes the control signal output from the determination control unit 401 on the main signal output from the signal termination unit 402. For example, the multiplexing and demultiplexing unit 404 may frequency-superimpose the control signal on the main signal. The multiplexing and demultiplexing unit 404 demultiplexes the control signal from the signal received from the user apparatus 300 and outputs the demultiplexed control signal to the determination control unit 401. The multiplexing and demultiplexing unit 404 outputs a signal (main signal) in which the control signal is demultiplexed to the signal termination unit 402 via the SW 403.

The optical interface unit 405 converts the electrical signal output from multiplexing and demultiplexing unit 404 into an optical signal. The optical interface unit 405 transmits the converted optical signal to the user apparatus 300 via an optical communication path.

The optical interface unit 406 receives an optical signal transmitted from the user apparatus 300 via the optical communication path, and converts the received optical signal into an electrical signal. The optical interface unit 406 outputs the electrical signal obtained by the conversion to the multiplexing and demultiplexing unit 404.

The user apparatus 300 includes an optical transceiver 301 and a control unit 330. The optical transceiver 301 includes an optical interface unit 321 (optical IF unit), a multiplexing and demultiplexing unit 322, a processing unit 323, a UNI_PHY (Tx) 324, a UNI_PHY (Rx) 325, and an optical interface unit 326 (optical IF unit).

The optical interface unit 321 converts the optical signal received from the Ph-GW 100 into an electrical signal. The optical interface unit 321 outputs the electrical signal obtained by the conversion to the multiplexing and demultiplexing unit 322. Hereinafter, the user apparatus performs photoelectric conversion, and loops back all signals at the time of loopback within the user apparatus (UNI_PHY) or loops back some signals and outputs the rest to the user while looping back.

The multiplexing and demultiplexing unit 322 demultiplexes the control signal from the signal received from the Ph-GW 100 and outputs the demultiplexed control signal to the control unit 330. The multiplexing and demultiplexing unit 322 outputs a signal (main signal) in which the control signal is demultiplexed to the processing unit 323. The multiplexing and demultiplexing unit 322 superimposes the control signal output from the control unit 330 on the main signal output from the processing unit 323. For example, the multiplexing and demultiplexing unit 322 may frequency-superimpose the control signal on the main signal. A user apparatus configuration including the processing unit is only an example, and there is also a configuration that does not include the processing unit.

The processing unit 323 is, for example, a regenerative repeater, and includes a reshaping function, a retiming function, and a regenerating function in that case. For example, the processing unit 323 is a multiplexing unit and a demultiplexing unit. For example, the processing unit 323 is a conversion unit that converts a signal from an access network into a signal format transmitted by APN. For example, the processing unit 323 is a framer that multiplexes and demultiplexes signals from an access network into transmission frames. The processing unit 323 is, for example, a MAC, and executes media access control for the main signal output from the multiplexing and demultiplexing unit 322 in this case.

The processing unit 323 defines and allocates an address (MAC address) for identifying an apparatus. The processing unit 323 may control a signal transmission timing. The MAC outputs the main signal to UNI_PHY(Tx) 324. The MAC may execute media access control for the electrical signal output from the UNI_PHY(Rx) 325. The processing unit 323 outputs the main signal to the multiplexing and demultiplexing unit 322.

Configurations of the multiplexing and demultiplexing unit 322 and the processing unit 323 do not need to be limited to those described above. For example, the multiplexing and demultiplexing unit 322 may be disposed closer to the network than the optical interface unit 321 and the optical interface unit 326. In this case, the multiplexing and demultiplexing unit 322 performs AMCC superimposition and separation on the optical signal. Further, when control signals are exchanged using OTN frames, GCC, or the like, the multiplexing and demultiplexing unit 322 and the processing unit 323 may function as an OTN framer.

The normality of the route may be determined using “Ethernet (registered trademark) Operation Administration Maintenance (OAM)”. The normality of the path may be determined using a control channel of a lower header whose payload is the main signal (user signal). For example, a general communication channel (GCC) of an optical transport network (OTN) may be used to determine the normality of the path.

The UNI_PHY(Tx) 324 is a transmission function unit in the physical layer of the user network interface. The UNI_PHY(Tx) 324 executes predetermined reception processing for the electrical signal (main signal) output from the processing unit 323, and transmits the main signal to the user side. The user side may be electrical or may be optical.

The UNI_PHY(Rx) 325 is a reception function unit in the physical layer of the user network interface. The UNI_PHY(Rx) 325 receives the main signal from the user side and executes predetermined transmission processing to output an electrical signal according to the main signal to the processing unit 323. The user side may be electrical or may be optical.

The optical interface unit 326 converts the control signal into an optical signal. The optical interface unit 326 transmits the optical signal obtained by the conversion to the Ph-GW 100.

The control signal reception unit 331 receives from the multiplexing and demultiplexing unit 322 the control signals demultiplexed by the multiplexing and demultiplexing unit 322. The control signal reception unit 331 operates according to information indicated by the received control signal. When the control signal is information indicating an instruction to execute loopback, the control signal reception unit 331 instructs the optical transceiver 301 to execute loopback according to the instruction. For example, the control signal reception unit 331 instructs the UNI_PHY(Tx) 324 to execute loopback of the main signal.

A flow of signal path normality determination processing in the first embodiment will be described. An example in which the Ph-GW generates and transmits the main signal for loopback, the user apparatus loops back the main signal, and the Ph-GW receives and terminates the looped back main signal will be described.

At a predetermined timing, the determination control unit 401 instructs the signal termination unit 402 to output the main signal according to a protocol that can be processed by the target user apparatus. The predetermined timing may be, for example, a timing at which a problem in communication with the user apparatus 300 is detected. This instruction may be an instruction from the APN controller 200 or an instruction from the access network management control unit 103.

Upon receiving the instruction, the signal termination unit 402 generates the main signal and outputs the main signal to the SW 403. The output main signal may be, for example, a signal with a predetermined content in the signal path normality determination. The determination control unit 401 generates a control signal for instructing execution of loopback and outputs the control signal to the multiplexing and demultiplexing unit 404. The multiplexing and demultiplexing unit 404 superimposes the control signal on the main signal and outputs the signal to the optical interface unit 405. The optical interface unit 405 converts the electrical signal input from multiplexing and demultiplexing unit 404 into an optical signal, and transmits the optical signal to the user apparatus 300 via the transmission path. A procedure is to instruct the user apparatus to loop back via a control signal or the like. Thereafter, it is correct to cause the signal termination unit according to the protocol of the user apparatus to transmit a loopback signal. This is because, when the loopback signal is transmitted before the user apparatus responds, there is concern that the user apparatus will transmit the loopback signal, which should not normally be transmitted, to the user side.

Upon receiving the optical signal from the access network management control unit 103, the optical interface unit 321 of the user apparatus 300 converts the received optical signal into an electrical signal and outputs the electrical signal to the multiplexing and demultiplexing unit 322. The multiplexing and demultiplexing unit 322 demultiplexes the received signal into the control signal and the main signal. The multiplexing and demultiplexing unit 322 outputs the control signal to the control unit 330 and outputs the main signal to the processing unit 323.

When the control signal reception unit 331 of the control unit 330 receives the control signal from the multiplexing and demultiplexing unit 322, the control signal reception unit 331 operates according to the content of the control included in the control signal. The control signal includes a signal indicating an instruction to execute loopback. In response to this instruction, the control signal reception unit 331 instructs the optical transceiver 301 to execute loopback of the main signal. The main signal received by the optical transceiver 301 is the main signal transmitted from the signal termination unit 402 that performs a protocol operation that can be processed by the optical transceiver 301. Therefore, the optical transceiver 301 can loop back the main signal without any problem. Since the response is usually slow compared to the control response or the main signal, the control signal is transmitted, and the main signal for loopback is transmitted after the user apparatus is ready for loopback in response to the control signal.

For example, the processing unit 323 may serve as a loopback point to execute loopback processing, or the UNI_PHY(Tx) 324 or UNI_PHY(Rx) 325 may serve as a loopback point to execute loopback processing. The loopback processing may be implemented as a full-channel loopback, may be implemented as a partial loopback, or may be implemented as a logical loopback, for example. Furthermore, when loopback processing is executed in the optical interface unit 321, the multiplexing and demultiplexing unit 322, or the processing unit 323, in-apparatus loopback, which will be described later, may be executed within an apparatus of the optical transceiver 301. In this case, for example, the control unit 330 may include an in-apparatus loopback control unit 334, which will be described later.

The looped back main signal is converted into an optical signal by the optical interface unit 326 and transmitted to the access network management control unit 103. In the case equivalent to Loop 1, the main signal is looped back between the optical IFs or immediately after the optical IF as seen from the access network (at the multiplexing and demultiplexing unit in FIGS. 2 to 5), and in the case equivalent to Loop 2, the main signal is looped back between Rx and Tx of UNI_PHY or immediately before Rx and Tx of UNI PHY as seen from the access network (processing unit in FIGS. 2 to 5). In the case of the loopback at the optical IF unit, there is a possibility that a control signal such as AMCC is included, but even when loopback is performed at the optical IF unit, the case of the control signal at an optical signal different from the main signal, or a case in which the control signal may be looped back using a removed processing unit or UNI_PHY may be a case in which the loopback signal does not include a control signal. In this state, when the control signal is also looped back, the control signal to be looped back is superimposed on or multiplexed with the main signal to be looped back, which does not include the control signal, and the control signal and the main signal are looped back. In the present embodiment, since the main signal is looped back using a protocol that can be used by the user apparatus, the control signal may also be looped back, but this is not essential. On the other hand, in an embodiment of the control signal loopback described below, loopback of the control signal is essential, but loopback of the main signal is not essential.

The looped back main signal is converted into an electrical signal at the optical interface unit 406, and is input to the signal termination unit 402, which has been a transmission source of the main signal. The signal termination unit 402 performs a predetermined evaluation on the input main signal according to the transmission confirmation. For example, an evaluation may be made as to whether the loopback has been performed correctly. The signal termination unit 402 outputs information indicating the evaluation result to the determination control unit 401. The determination control unit 401 performs the signal path normality determination regarding the target user apparatus on the basis of the evaluation result received from the signal termination unit 402. The determination control unit 401 may output the determination result to another apparatus or record the determination result in a storage apparatus as a log.

According to the communication system 1 of the first embodiment configured in this way, the main signal that is a loopback target is transmitted to the user apparatus 300 using a signal of a protocol that can be processed by the user apparatus 300. Therefore, it is possible to perform the loopback at a loopback point after the main signal passes through the path after optical-to-electrical conversion in the optical transceiver 301. Therefore, it is possible to determine the normality of the signal path including the inside of the user apparatus 300 in a protocol-independent APN that does not depend on a specific communication protocol or modulation scheme.

The process of determining the normality of both up and down sections using loopback has been described above. Only one optical signal from the access network management control unit 103 to the user apparatus 300 and from the user apparatus 300 to the access network management control unit 103 is passed, and only the normality only in that direction may be determined. In that case, for a downstream (from the access network management control unit 103 to the user apparatus 300), the user apparatus 300 reports a determination result using the control signal. In the case of upstream (from the user apparatus 300 to the access network management control unit 103), the user apparatus 300 sends a signal to the access network management control unit 103 according to the instruction in the control signal.

When a communication system includes an optical signal transmission and reception apparatus, one opposing apparatus (Ph-GW) selectively generates an optical signal in a format that can be transmitted and received by the other opposing apparatus, and loops back the generated optical signal to the other opposing apparatus. The other opposing apparatus (the user apparatus) receives the looped back optical signal or the response thereto (in a format that can be transmitted and received), and determines whether a signal path including a signal path between the one opposing apparatus and the other opposing apparatus is normal on the basis of the received looped back optical signal or the response thereto.

(B1) The user apparatus loops back, and a system configuration pattern of a plurality of main signal termination units on the Ph-GW side (“format selection +loopback side: apparatus on the Ph-GW side” and “generation, transmission, reception, and termination side: user apparatus”), the apparatus on the Ph-GW side selects the main signal termination unit according to the main signal used by the opposing apparatus (here, the user apparatus), the main signal termination unit of the opposing apparatus (here, user apparatus) generates the normality determination request using the main signal, the main signal termination unit selected by the apparatus on the Ph-GW side transmits the response regarding the normality determination in response to the request, the main signal termination unit of the user apparatus terminates the received response, or the apparatus on the Ph-GW side selects the main signal termination unit according to the main signal used by the opposing apparatus (here, the user apparatus), the main signal termination unit of the opposing apparatus (here, the user apparatus) generates a normality determination signal using that main signal, the main signal termination unit selected by the apparatus on the Ph-GW side loops back and transmits the normality determination signal, and the main signal termination unit of the opposing apparatus (user apparatus here) terminates the received loopback (loopback signal) (not shown).

The optical cross-connect unit and the like are set so that the access network management control unit and the user apparatus can communicate. The access network management control unit selects the termination unit of the main signal of the protocol according to the user apparatus. The access network management control unit instructs the user apparatus to generate and transmit an upstream main signal for a normality determination. The instruction may be a control signal or may be the main signal. In the case of the control signal, the termination unit according to the user apparatus may be selected after the instruction. In the case of using the main signal, since the main signal is used for the instruction, the instruction is given after selection. The user apparatus generates and transmits an upstream main signal for a normality determination. When there is no response, or the like in the control signal, it is not necessary to modulate the main signal with the control signal or to superimpose the control signal on the main signal. The access network management control unit loops back and transmits the upstream main signal or a response thereto as a downstream main signal. That is, the signal received by the optical IF unit 406 is looped back by the selected signal termination unit 402, and the optical IF unit 405 outputs the looped back signal. When no instruction or the like is given by the control signal, the main signal may not be modulated with the control signal or the control signal may not be superimposed on the main signal. The looped back downstream main signal is received, terminated, and determined by the user apparatus. With the passage of time or an instruction from the access network management control unit, the generation and transmission of the main signal for determining the normality of the user apparatus is released, and the determination result is acquired from the user apparatus. The instruction at this time may be a control signal or may be the main signal. The acquisition at this time may be either a control signal or the main signal.

Here, when the user apparatus is connected to the access network management control unit, a connection was changed at the optical cross-connect unit and connected. Such a connection may be made in other aspects.

(B2) The PH-GW loops back, and a system configuration pattern of a plurality of main signal termination units on the user apparatus side (“format selection+generation, transmission, reception, and termination side: user apparatus” and “loopback side: apparatus on the Ph-GW side”), the user apparatus side selects the main signal termination unit according to the main signal used by the opposing apparatus (here, the apparatus on the Ph-GW side), the selected main signal termination unit generates a normality determination request using the main signal, the opposing apparatus (here, the apparatus on the Ph-GW side) transmits the response regarding the normality determination in response to the request, the selected main signal termination unit of the user apparatus terminates the received response or the user apparatus selects the main signal termination unit according to the main signal used by the opposing apparatus (here, the apparatus on the Ph-GW side), the selected main signal termination unit generates a normality determination signal using the main signal, the opposing apparatus (here, the apparatus on the Ph-GW side) loops back and transmits the normality determination signal, and the selected main signal termination unit of the user apparatus terminates the received loopback (loopback signal).

A main signal termination unit (signal termination unit) corresponding to the signal format used by the opposing apparatus may be disposed in the user apparatus. The optical cross-connect unit and the like are set so that the access network management control unit and the user apparatus can communicate. The access network management control unit selects the main signal termination unit (signal termination unit) disposed in the user apparatus. The user apparatus transmits the main signal at the selected signal termination unit. Ph-GW loops back the main signal. The user apparatus receives and terminates the looped back downstream main signal, and determines the normality.

As described above, for example, the first user apparatus (user apparatus 300-1) or the first control apparatus (access network management control unit 103-1) loops back the first main signal transmitted from the second user apparatus or the second control apparatus that generates and terminates the main signal in a signal format selected on the basis of the signal format used by the opposing second user apparatus (user apparatus 300-2) or the second control apparatus (access network management control unit 103-2). The second user apparatus or second control apparatus determines whether the signal path including the section between the second user apparatus or second control apparatus and the first user apparatus or first control apparatus is normal, on the basis of the looped back first main signal.

For example, the first user apparatus (user apparatus 300-1) or the first control apparatus (access network management control unit 103-1) may loop back the second main signal transmitted from the second user apparatus (user apparatus 300-2) or the second control apparatus (access network management control unit 103-2) in a signal format selected on the basis of the signal format used by the opposing second user apparatus (user apparatus 300-2) or the second control apparatus (access network management control unit 103-2). The first user apparatus (user apparatus 300-1) or the first control apparatus (access network management control unit 103-1) may loop back the second main signal transmitted from the third user apparatus or the third control apparatus in a signal format selected on the basis of the signal format used by the opposing second user apparatus (user apparatus 300-2) or the second control apparatus (access network management control unit 103-2). The second user apparatus or second control apparatus determines whether the signal path including the section between the second user apparatus or second control apparatus and the first user apparatus or first control apparatus is normal, on the basis of the looped back second main signal.

For example, the first user apparatus (user apparatus 300-1) or the first control apparatus (access network management control unit 103-1) may respond with a second main signal or a third main signal to the first main signal transmitted from the second user apparatus or the second control apparatus that generates and terminates the main signal in a signal format selected on the basis of the signal format used by the opposing second user apparatus (user apparatus 300-2) or the second control apparatus (access network management control unit 103-2). The second user apparatus or second control apparatus determines whether the signal path including the section between the second user apparatus or second control apparatus and the first user apparatus or first control apparatus is normal, on the basis of the second main signal or third main signal used in the response.

For example, the first user apparatus (user apparatus 300-1) or the first control apparatus (access network management control unit 103-1) may respond with a fourth main signal to the second main signal transmitted from the second user apparatus (user apparatus 300-2) or the second control apparatus (access network management control unit 103-2) in a signal format selected on the basis of the signal format used by the opposing second user apparatus (user apparatus 300-2) or the second control apparatus (access network management control unit 103-2). The first user apparatus (user apparatus 300-1) or the first control apparatus (access network management control unit 103-1) may respond with the fourth main signal to the second main signal transmitted from the third user apparatus or the third control apparatus in a signal format selected on the basis of the signal format used by the opposing second user apparatus (user apparatus 300-2) or the second control apparatus (access network management control unit 103-2). The second user apparatus or second control apparatus determines whether the signal path including the section between the second user apparatus or second control apparatus and the first user apparatus or first control apparatus is normal, on the basis of the fourth main signal used for the response.

### Modification Example of First Embodiment

Coping with a case in which the Ph-GW does not receive the main signal to be the downstream signal (when the main signal does not reach the Ph-GW from the outside of a normality determination target section) will be described.

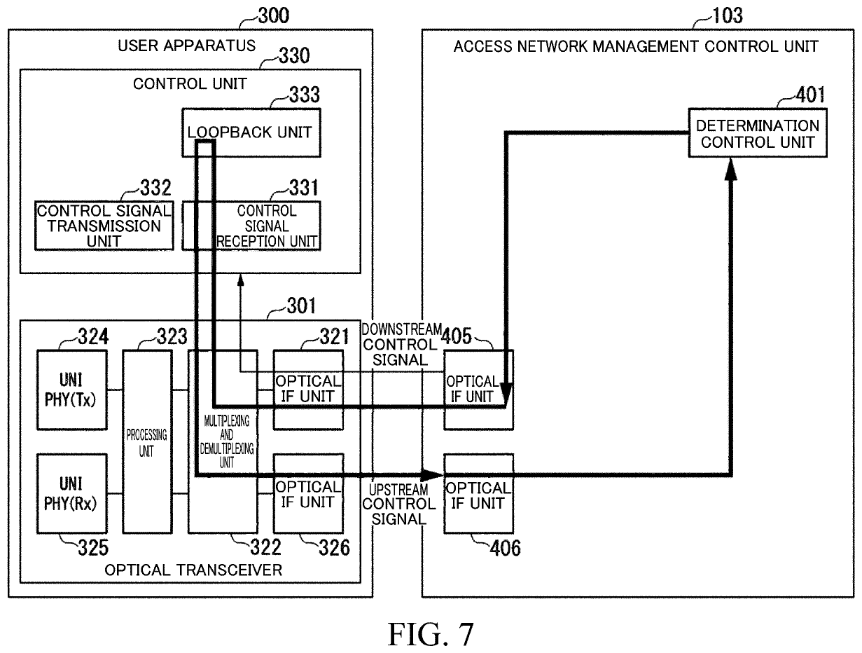

In the main signal loopback in which the normality determination result is received from the opposing apparatus, the apparatus on the opposite side in the normality determination target section, for example, another Ph-GW or user apparatus is instructed to perform any one or both the generation and termination of the main signal for a normality determination, and in the case of the termination, a determination result may be acquired from the apparatus. The signal termination unit may be used only when instructions cannot be given due to a break in the path, or when the generation or termination is not performed according to the instruction even when the instruction is given. In a configuration other than the configuration shown in FIG. 7, which will be described later, in the case of an error, a configuration example shown in FIG. 7, which will be described later, may be used.

In main signal loopback in which the opposing apparatus is instructed to loop back, the apparatus on the opposite side of the normality determination target section, such as another Ph-GW or user apparatus may be instructed to respond to or loop back the main signal for a normality determination. The signal termination unit may be used only when the instruction cannot be given due to a break in the path, or when the instruction or loopback is not performed according to the instruction even when the instruction is given. In a configuration other than the configuration shown in FIG. 7, which will be described later, in the case of an error, the configuration example shown in FIG. 7, which will be described later, may be used.

### Second Embodiment

### Control Signal Loopback

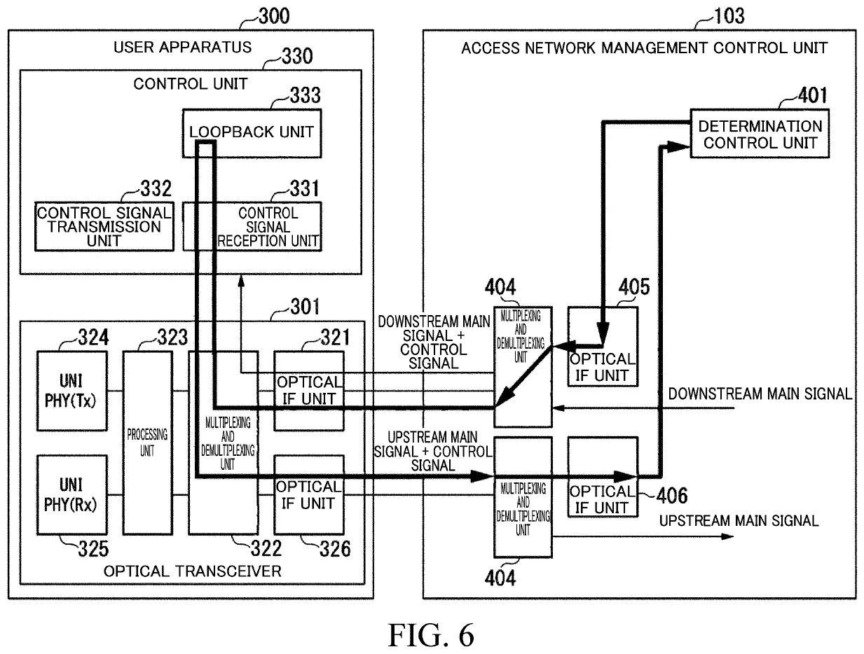

FIGS. 6 to 8 are diagrams showing a communication system 1 of the second embodiment. In FIGS. 6 to 8, among the apparatuses included in the communication system 1, only the apparatuses regarding one section that is the signal path normality determination target are shown. In the second embodiment, an example in which the access network management control unit 103 performs the signal path normality determination for the user apparatus 300 connected to the host apparatus (Ph-GW 100) will be described. For example, the access network management control unit 103-2 in FIG. 1 performs the signal path normality determination on the user apparatus 300-2. The normality determination may be performed in sections other than a section “between the Ph-GW and the user apparatus” described in the first embodiment.

When the control signal and the main signal are connected to different optical IF units in loopback of the control signal, regarding the main signal, the optical IF unit connected to the multiplexing and demultiplexing unit 322 is the signal termination unit for the main signal, and regarding the control signal, the optical IF unit connected to the multiplexing and demultiplexing unit 322 is on the control signal side, not on the signal termination unit side for the main signal.

The access network management control unit 103 transmits a control signal for instructing loopback to the user apparatus 300 (target user apparatus) connected to the section that is a signal path normality determination target. In the loopback in the second embodiment, the Ph-GW does not need to generate and terminate the main signal according to the protocol used by the user apparatus 300.

Regarding the access network management control unit 103, on the network side from the multiplexing and demultiplexing unit 404, the control signal is looped back by the determination control unit 401 and generated and terminated. That is, the access network management control unit 103 determines whether the internal signal path (internal path) of the access network management control unit 103 is normal on the basis of the control signal looped back by the determination control unit 401.

Regarding the user apparatus 300, on the user side from the multiplexing and demultiplexing unit 322, the control signal is looped back or generated and terminated by the control unit 330, and the main signal is looped back or generated and terminated at the UNI side. In both cases, the multiplexing and demultiplexing unit 322 multiplexes the signal. When the optical IF unit is common for the control signal and the main signal, the network side from the multiplexing and demultiplexing unit 322 is common, and thus, both are transmitted and received by the optical IF unit. When at least one of the transmission and reception of the optical IF unit of the user apparatus is different between the control signal and the main signal, different transmission, reception, or both are performed by the optical IF unit corresponding to the control signal or the main signal. In the user apparatus, control signal loopback usually involves main signal processing.

In the loopback itself in the second embodiment, the normality of a portion where the control signal is not passed, for example, a path between the UNI_PHY and the processing unit 323 is not determined. The control signal to be used is a control signal commonly used in a plurality of the user apparatuses 300 (which may be all user apparatuses 300 of the communication system 1) corresponding to optical signals in different transmission and reception formats (forms of protocols, modulation schemes, modulation speeds, and code). In particular, this is a control signal that is commonly used by user apparatuses with different main signal protocols. A specific example of such a control signal is, for example, AMCC. For example, there is a control signal for at least one of the transmitting side and the receiving side that uses different optical IF units, light sources, receivers, and main signals, which are does not depend on a format of the main signal. Other specific examples of such a control signal includes Ethernet (registered trademark) OAM, GCC of OTN frame, and the like. Ethernet (registered trademark) OAM can carry different protocols when encapsulated in Ethernet (registered trademark). An OTN frame can pack client signals of different protocols into the OTN frame. When Ethernet (registered trademark) OAM, GCC of the OTN frame, or the like is used, the control signal is time-division multiplexed with the main signal. Therefore, the delay may vary in Ethernet (registered trademark) OAM. However, other communication quality of the main signal itself is not affected. On the other hand, AMCC loopback is modulated by being superimposed on the main signal. Therefore, the communication quality of the main signal itself may be affected. In order to realize such processing, the access network management control unit 103 includes a determination control unit 401, a multiplexing and demultiplexing unit 404, an optical interface unit (optical IF unit) 405, and an optical interface unit (optical IF unit) 406.

The determination control unit 401 outputs a control signal indicating execution of loopback to the multiplexing and demultiplexing unit 404. The control signal used is a signal that can be used in common by a plurality of user apparatuses 300 corresponding optical signals of different transmission and reception formats (protocols, modulation schemes, modulation speeds, and code formats). Upon receiving the looped back control signal from the user apparatus 300, the determination control unit 401 determines the normality of the route that is a determination target on the basis of the received signal.

The multiplexing and demultiplexing unit 404 superimposes the control signal output from the determination control unit 401 on the main signal output from another apparatus (for example, a signal termination unit). For example, the multiplexing and demultiplexing unit 404 superimposes a control signal (for example, AMCC) on the optical signal of the main signal to the user apparatus 300 or the optical signal of another carrier. For example, the multiplexing and demultiplexing unit 404 may frequency-superimpose the control signal on the main signal. The multiplexing and demultiplexing unit 404 demultiplexes a control signal from the signal received from the user apparatus 300 and outputs the demultiplexed control signal to the determination control unit 401. The multiplexing and demultiplexing unit 404 outputs a signal (main signal) from which the control signal is demultiplexed to another apparatus (for example, a signal termination unit).

The light source for the optical signal used as the loopback signal may be separate from the light source for the main signal, or there may be a plurality of light sources. The light source for the optical signal used as the loopback signal may be shared as the light source for the optical signal used as the main signal. When the light source for the main signal and the light source for the control signal are different light sources, the optical interface unit 406 may receive at least the signal from the light source for the control signal. When the light source for the main signal and the light source for the control signal are shared, the signal from the light source is received.

When the light source for the main signal and the light source for the control signal are different light sources, the loopback reception unit 310 may receive at least a signal of the light source for the control signal. When the light source for the main signal and the light source for the control signal are shared, the signal from the light source is received.

The optical interface unit 405 converts the electrical signal output from multiplexing and demultiplexing unit 404 into an optical signal. The optical interface unit 405 transmits the optical signal obtained by the conversion to the user apparatus 300 via an optical communication path.

The optical interface unit 406 receives an optical signal transmitted from the user apparatus 300 via the optical communication path, and converts the received optical signal into an electrical signal. The optical interface unit 406 outputs the electrical signal obtained by the conversion to the multiplexing and demultiplexing unit 404.

The user apparatus 300 includes an optical transceiver 301 and a control unit 330. Since the optical transceiver 301 of the second embodiment has the same configuration as the optical transceiver 301 of the first embodiment, description thereof will be omitted.

In the first embodiment, when the instruction, generation termination, or return is performed using only the main signal, there is no need to transmit the control signal to the control unit of the user apparatus. In the second embodiment, when main signal generation/termination and loopback are not essential, control signals are mainly exchanged with a control unit in the user apparatus. In this respect, the second embodiment is not similar to the first embodiment.

The control signal reception unit 331 receives from the multiplexing and demultiplexing unit 322 the control signals demultiplexed by the multiplexing and demultiplexing unit 322. The control signal reception unit 331 operates according to information indicated by the received control signal. When the control signal is information indicating an instruction to execute loopback, the control signal reception unit 331 instructs the loopback unit 333 to execute loopback according to the instruction.

The control signal transmission unit 332 outputs a control signal that is a transmission target to the multiplexing and demultiplexing unit 322. When receiving an instruction to execute loopback from the control signal reception unit 331, the loopback unit 333 executes loopback processing according to the instruction. A target of loopback processing in the loopback unit 333 is, for example, a control signal. The loopback processing may be implemented as a full-channel loopback, may be implemented as a partial loopback, or may be implemented as a logical loopback, for example. The looped back control signal is converted into an optical signal by the optical interface unit 326 and transmitted to the access network management control unit 103.

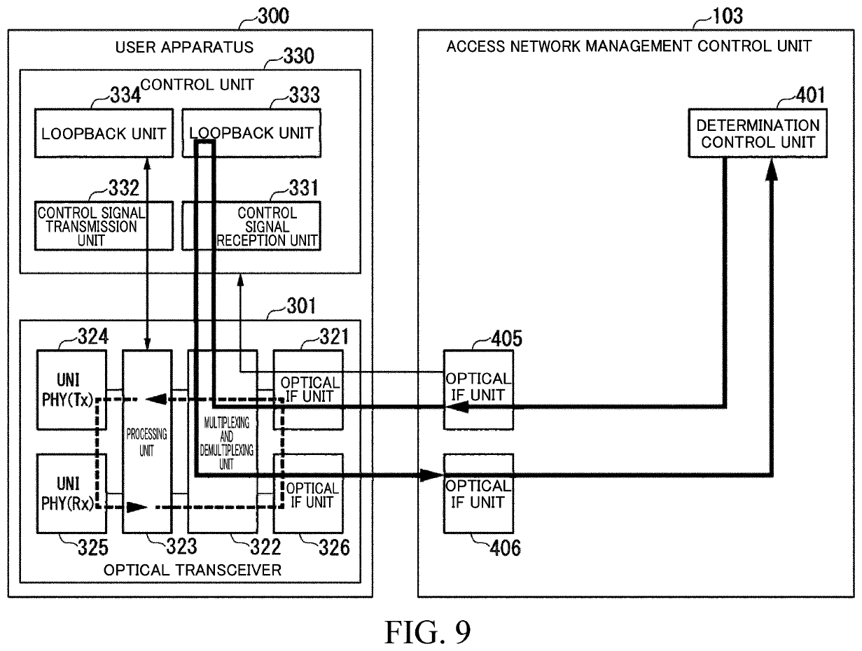

In FIGS. 7 and 9, the optical IF unit or the like may transmit and receive the optical signal with which the control signal (for example, AMCC) can be received, without the optical IF unit or the like damaging light not on the basis of the protocol of the user apparatus with light such as continuous light (CW light). In FIGS. 7 and 9, in the control signal loopback, the main signal according to the signal format of the user apparatus is not transmitted and received as in the first embodiment as long as the control signal can be transmitted and received. Therefore, the optical signal may be unmodulated continuous light as long as the control signal is carried.

FIGS. 7 and 9 are suitable when the main signal does not reach the access network management control unit from the opposite side of the normality determination section. In FIGS. 7 and 9, it is assumed that the connection of the optical cross-connect unit is switched from a user apparatus-user apparatus path to a path between the user apparatus and the access network management control unit. In FIGS. 6 and 8 in which it is assumed to connect and split in the middle of the path without switching the connection of the optical cross-connect unit, when the path switching is not executed, and the main signal does not reach the access network management control unit from the opposite side of the section where normality is determined, the multiplexing and demultiplexing unit is built into the access network management control unit, unlike in FIGS. 7 and 9, but this is substantially the same as in FIGS. 7 and 9.

In addition, in FIGS. 6 and 8, since a normal user apparatus user apparatus connection is monitored, there is no switching of the optical cross-connect unit. In FIGS. 7 and 9, switching is performed from the normal user apparatus-user apparatus connection to the user apparatus-control unit for a normality determination.

An optical cross-connect unit or the like is set so that the access network management control unit and the user apparatus can communicate. The access network management control unit instructs the user apparatus 300 to loop back the control signal. The instruction may be a control signal. The same applies below.

In FIGS. 6 and 8, the control signal is multiplexed by modulating the main signal from outside the normality determination section (FIG. 8), or the control signal is multiplexed with another optical signal (FIG. 6). In FIG. 8, the main signal for multiplexing the control signal is not input, but unmodulated continuous light, for example, may be input instead of the main signal for carrying the control signal when the main signal does not come from outside the section where the normality is determined.

As described above, in FIGS. 6 and 8, since a monitor originally built into the path at the time of normal main signal transmission is assumed, the path of the optical cross-connect unit regarding the main signal is not changed. On the other hand, in the cases of FIGS. 7 and 9, all generations or all terminations are performed without splitting and multiplexing the main signal, and it is essential to perform switching to connect the optical cross-connect unit to the access system control unit.

The user apparatus 300 modulates the upstream main signal using a downstream control signal or a response thereto as an upstream control signal, or superimposes the downstream control signal or the response thereto on the upstream main signal as the upstream control signal, and the loopback unit 333 loops back the signal in an upstream direction. The access network management control unit receives and terminates a loopback upstream control signal, and performs a determination. With the passage of time or an instruction from the access network management control unit, the loopback of the control signal of the user apparatus is released. The instruction may be a control signal. When the control signal is multiplexed as another optical signal, the access network management control unit receives and terminates the control signal. When the control signal is multiplexed with the main signal, a part of the upstream signal is split or light is generated by nonlinear optical effects, or the like, light from which at least the control signal can be read is generated, and access network management control unit terminates the light. At least a portion of the upstream signal is output outside the normality determination target section.

An optical cross-connect unit or the like is set so that the access network management control unit and the user apparatus can communicate. The access network management control unit selects the termination unit (signal termination unit) of the main signal of the protocol according to the user apparatus. The instruction may be a control signal. The user apparatus modulates the upstream main signal with the upstream control signal for a normality determination, or superimposes the upstream control signal for a normality determination on the upstream main signal, and transmits a resultant signal in the upstream direction. The access network management control unit modulates the downstream main signal using the upstream control signal or a response thereto as a downstream control signal, or superimposes the upstream control signal or the response thereto on the downstream main signal as a downstream control signal, loops back the signal in the downstream direction, and transmits the signal. That is, the signal received by the optical IF unit 406 is looped back and the optical IF unit 405 outputs the signal. The user apparatus 300 receives and terminates the looped back downstream control signal, and performs a determination. With the passage of time or an instruction from the access network management control unit, the generation of the control signal for a normality determination of the user apparatus 300, and the modulation of the upstream main signal with the generated control signal or superimposition of the upstream main signal are released, and the optical IF unit acquires the determination result from the user apparatus. The instruction may be a control signal.

In FIGS. 6 and 8, the access network management control unit does not generate an optical signal such as unmodulated continuous light instead of the main signal for carrying the control signal when the main signal does not come from outside the section where the normality is determined. In FIGS. 6 and 8, the control signal is multiplexed by modulating the main signal from outside the normality determination section (FIG. 8), or the control signal is multiplexed with another optical signal (FIG. 6). As described above, in FIGS. 6 and 8, since a monitor originally built into the path at the time of normal main signal transmission is assumed, the path of the optical cross-connect unit regarding the main signal is not changed. On the other hand, in the cases of FIGS. 7 and 9, all generations or all terminations are performed without splitting and multiplexing the main signal, and it is essential to perform connection switching to connect the optical cross-connect unit to the access system control unit.

In FIGS. 6 and 8, since the main signal and the control signal are multiplexed and demultiplexed inside the access network management control unit, this is similar to a monitor.

In FIGS. 6 and 8, when a transmission unit (optical IF unit) that transmits an optical signal that is looped back by the opposing apparatus is disposed in the Ph-GW for a normality determination, a transmission unit (optical IF unit) may be disposed in addition to the access network management control unit 103 connected via the optical cross-connect unit. For example, a reception unit (optical IF unit) may be disposed at a position where the optical signal can be output to the loopback apparatus, via the optical coupler/splitter or the optical multiplexer/demultiplexer installed outside the input port or output port to the optical cross-connect unit. For example, a transmission unit (optical IF unit) may be disposed in a monitoring unit that monitors the optical intensity of optical signals on at least one of the input side and output side of the Ph-GW or exchanges control signals with the user apparatus. Instead of combined or multiplexed light being output through the optical coupler/splitter or the optical multiplexer/demultiplexer, light generated by an optical nonlinear effect of the light to be looped back may be output.

When a reception unit (optical IF unit) that receives at least a part of the optical signal looped back by the opposing apparatus is disposed in the Ph-GW for a normality determination, a reception unit (optical IF unit) may be disposed in addition to the access network management control unit connected via the optical cross-connect unit. For example, a reception unit (optical IF unit) may be disposed at a position where the optical signal looped back from the loopback apparatus or at least a part of a component thereof can be input, via the optical coupler/splitter or the optical multiplexer/demultiplexer installed outside the input port or output port to the optical cross-connect unit. For example, a transmission unit (optical IF unit) may be disposed in a monitoring unit that monitors the optical intensity of optical signals on at least one of the input side and output side of the Ph-GW or exchanges control signals with the user apparatus. Instead of split or demultiplexed light input through the optical coupler/splitter or the optical multiplexer/demultiplexer, light generated by, for example, an optical nonlinear effect of looped back light may be input.

Effectively, this corresponds to a case where light for modulation with a control signal is inserted in each of FIGS. 6 to 8, which will be described later. When a control signal from a separate light source independent of the main signal is superimposed, it is not necessary to insert the main signal that does not conform to the protocol of the user apparatus or unmodulated light (CW light) unless there is a reason such as aligning gains of amplifiers in the path.

The access network management control unit 103 may determine the normality of the route using the AMCC signal of the APN. The access network management control unit 103 may use “Ethernet (registered trademark) Operation Administration Maintenance (OAM)” to determine the normality of the route. The access network management control unit 103 may determine the normality of the route using a control channel of a lower header whose payload is the main signal (user signal). The normality of the route may be determined by using, for example, a general communication channel (GCC) of an optical transport network (OTN) as the control channel.

A flow of signal path normality determination processing in the second embodiment will be described. Hereinafter, when there is a flow regarding control signal loopback, and a response to the normality determination request is received, this is used (a response is looped back to the request, instead of looping back predetermined loopback information according to a loopback instruction).

At a predetermined timing, the determination control unit 401 generates a control signal for instructing execution of loopback and outputs the control signal to the multiplexing and demultiplexing unit 404. The predetermined timing may be, for example, a timing at which a problem in communication with the user apparatus 300 is detected. The timing may be a timing according to an instruction from the controller. The multiplexing and demultiplexing unit 404 outputs a control signal to the optical interface unit 405. The optical interface unit 405 converts the electrical signal input from multiplexing and demultiplexing unit 404 into an optical signal, and transmits the optical signal to the user apparatus 300 via the transmission path.

Upon receiving the optical signal from the access network management control unit 103, the optical interface unit 321 of the user apparatus 300 converts the received optical signal into an electrical signal and outputs the electrical signal to the multiplexing and demultiplexing unit 322. The multiplexing and demultiplexing unit 322 demultiplexes the control signal from the received signal and outputs the control signal to the control unit 330.

When the control signal reception unit 331 of the control unit 330 receives the control signal from the multiplexing and demultiplexing unit 322, the control signal reception unit 331 operates according to the content of the control included in the control signal. The control signal includes a signal indicating an instruction to execute loopback. In response to this instruction, the control signal reception unit 331 instructs the loopback unit 333 to execute loopback of the control signal. The loopback unit 333 performs loopback processing on the received control signal to output the control signal to the multiplexing and demultiplexing unit 322.

The looped back control signal is converted into an electrical signal by the optical interface unit 406, and is input to the determination control unit 401, which has been the transmission source of the control signal. The determination control unit 401 performs a predetermined evaluation on the input control signal according to the transmission confirmation. For example, an evaluation may be made as to whether the loopback has been performed correctly. The determination control unit 401 performs the signal path normality determination regarding the target user apparatus on the basis of the evaluation result. The determination control unit 401 may output the determination result to another apparatus or record the determination result in a storage apparatus as a log.

As described above, for example, the first user apparatus (user apparatus 300-1) or the first control apparatus (access network management control unit 103-1) responds with a second control signal to the first control signal transmitted from the opposing second user apparatus (user apparatus 300-2) or the second control apparatus (access network management control unit 103-2). The second user apparatus or second control apparatus determines whether the signal path including the section between the first user apparatus or first control apparatus and the second user apparatus or second control apparatus is normal, on the basis of the second control signal used in the response.

For example, the first user apparatus (user apparatus 300-1) or the first control apparatus (access network management control unit 103-1) loops back the first control signal transmitted from the opposing second user apparatus (user apparatus 300-2) or the second control apparatus (access network management control unit 103-2). The second user apparatus or second control apparatus determines whether the signal path including the section between the first user apparatus or first control apparatus and the second user apparatus or second control apparatus is normal, on the basis of the looped back first control signal.

For example, when the optical signal for carrying the second control signal does not reach the first control apparatus (user apparatus 300-1), the first control apparatus (user apparatus 300-1) may multiplex the second control signal with another optical signal different from the main signal, and when the optical signal for carrying the second control signal reaches the control apparatus, the first control apparatus (user apparatus 300-1) may multiplex the second control signal with the optical signal for carrying the second control signal and determine whether or not the signal path is normal on the basis of the other optical signal or the second control signal multiplexed on the optical signal.

According to the communication system 1 of the second embodiment configured in this way, a control signal that can be processed by the user apparatus 300 is transmitted to the user apparatus 300. Therefore, it is possible to perform the loopback at the loopback point (loopback unit 333) after the main signal passes through the path after optical-to-electrical conversion in the optical transceiver 301. Therefore, in the protocol-independent APN that does not depend on a specific communication protocol or modulation scheme, the normality of the signal path including the inside of the user apparatus 300 (for example, the optical interface unit 321, the multiplexing and demultiplexing unit 322, and the optical interface unit 326) can be determined.

Such processing is superior to other signal path normality determinations in the following points. In main signal loopback processing of the related art, whether or not the processing can be performed depends on the protocol that can be processed by the user apparatus 300. Therefore, as in the first embodiment, it is necessary to additionally include device compatible with various main signals depending on the signal format used by the user apparatus 300 on the station side. On the other hand, in the communication system 1 of the second embodiment, there is no protocol dependence, and there is no need to additionally include the device compatible with various main signals on the station side. Further, OTDR requires additional dedicated device on the station side. On the other hand, in the communication system 1 of the second embodiment, there is no need to additionally include a dedicated device on the station side. Furthermore, in a scheme for installing a monitor, it is necessary to additionally include a monitor device on the station side. On the other hand, in the communication system 1 of the second embodiment, there is no need to additionally include a special monitoring device such as an OTDR on the station side.

The control signal transmission unit 332 communicates with the Ph-GW via the multiplexing and demultiplexing unit 322. For example, the control signal transmission unit 332 responds to a loopback instruction. For example, the control signal transmission unit 332 responds to the Ph-GW with the result of the normality determination determined by the user apparatus.

### First Modification of Second Embodiment

### Main Signal Loopback+Control Signal Loopback

The access network management control unit 103 may perform the control signal loopback, may perform the main signal loopback, or may perform loopback of both the control signal and the main signal. In the present embodiment, a communication system includes apparatuses that communicate with each other using optical signals, and one of the apparatuses transmits a control signal to the other apparatus using an optical signal. The other apparatuses loop a control signal or a response thereto back to one apparatus. An example of a communication system in which one apparatus receives the looped back control signal or the response thereto and determines whether a signal path including a signal path between the one apparatus and another apparatus is normal is shown. When both the loopback of the control signal and the loopback of the main signal are performed, the control signal and the main signal are looped back.

More specifically, a communication system includes an apparatus that superimposes the control signal on the optical signal of the host apparatus or the optical signal from the other apparatus or modulates the optical signal of the host apparatus or the optical signal from the other apparatus to transmit and receive the control signal, the one opposing apparatus generates an optical signal in a format that can be transmitted and received by the other opposing apparatus (an optical signal that can receive control signals such as AMCC without damage to the optical IF unit, or the like), and transmits a control signal superimposed on the generated optical signal or modulating the generated optical signal to the other opposing apparatus. The other opposing apparatus superimposes the control signal on the optical signal of the host apparatus or the optical signal from the other apparatus or modulates the optical signal of the host apparatus or the optical signal from the other apparatus to loop back and transmit the received control signal or a response thereto. The one opposing apparatus superimposes or modulates the optical signal and receives the looped back control signal or a response thereto. The one opposing apparatus determines whether the signal path including the signal path between the one opposing apparatus and the other opposing apparatus is normal, on the basis of the received looped back control signal or the response thereto.

(C1) The user apparatus loops back, and a system configuration pattern of a plurality of main signal termination units on the Ph-GW side (“format selection+generation, transmission, reception, and termination side: apparatus on the Ph-GW side” and “loopback side: user apparatus”), the apparatus on the Ph-GW side selects the main signal termination unit (signal termination unit) according to the main signal used by the opposing apparatus (here, the user apparatus) as shown, the selected main signal termination unit generates a normality determination request using the main signal, the opposing apparatus (here, the user apparatus) transmits the response regarding the normality determination in response to the request, the selected main signal termination unit of the apparatus on the Ph-GW side terminates the received response, or the apparatus on the Ph-GW side selects the main signal termination unit (the signal termination unit) according to the main signal used by the opposing apparatus (here, the user apparatus), the selected main signal termination unit generates a normality determination signal with the main signal, the opposing apparatus (here, the user apparatus) loops back the normality determination signal, and the selected main signal termination unit of the apparatus on the Ph-GW side terminates the received loopback (loopback signal). In the present embodiment, the apparatus on the Ph-GW side generates the normality determination request using the control signal, in addition to the main signal normality determination request and a response thereto, or the main signal normality determination signal and its return, the opposing apparatus (here, the user apparatus) transmits the response regarding the normality determination in response to the request, the apparatus on the Ph-GW side terminates the received response or the apparatus on the Ph-GW side generates the normality determination signal, the opposing apparatus (here, the user apparatus) loops back and transmits the normality determination signal, the apparatus on the Ph-GW side terminates the received loopback (loopback signal) or the user apparatus generates the normality determination request using the control signal, the opposing apparatus (here, the apparatus on the Ph-GW side) transmits the response regarding the normality determination in response to the request, the user apparatus terminates the received response or the user apparatus generates the normality determination signal using the control signal, the opposing apparatus (here, the apparatus on the Ph-GW side) loops back and transmits the normality determination signal, and the user apparatus terminates the received loopback (loopback signal).

The optical cross-connect unit or the like is set so that the access network management control unit and the user apparatus can communicate. The access network management control unit selects the termination unit for the main signal of the protocol according to the user apparatus. The access network management control unit instructs the user apparatus to loop back the control signal. The instruction may be a control signal or may be the main signal. However, the control signal is more appropriate for acquiring instructions. The same applies below. In the case of the control signal, a termination unit corresponding to the user apparatus may be selected after the instruction. The access network management control unit generates a downstream main signal not limited to the normality determination using a protocol according to the user apparatus, modulates the main signal with the downstream control signal for a normality determination, or superimposes the downstream control signal for a normality determination on the main signal, and transmits the signal in the downstream direction. The user apparatus modulates the upstream main signal with the downstream control signal or the response thereto as an upstream control signal, or superimposes the downstream control signal or the response thereto on the upstream main signal as an upstream control signal, and loops back and transmits a resultant signal in the upstream direction. The looped back upstream control signal is received, terminated, and determined by the access network management control unit. With the passage of time or an instruction from the access network management control unit, the loopback of the control signal of the user apparatus is released. The instruction may be the control signal or the main signal. Furthermore, after the loopback is released, a connection form of the light cross-connect unit is looped back.

(C2) The user apparatus loops back, and a system configuration pattern of a plurality of main signal termination units on the user apparatus side (“format selection+loopback side: user apparatus”and “generation, transmission, and reception termination side: apparatus on the Ph-GW side”), the user apparatus selects the main signal termination unit (signal termination unit) according to the main signal used by the opposing apparatus (here, the apparatus on the Ph-GW side), the main signal termination unit of the opposing apparatus (here, the apparatus on the Ph-GW side) generates the normality determination request using the main signal, the main signal termination unit selected by the user apparatus transmits the response regarding the normality determination in response to the request, the main signal termination unit of the apparatus on the Ph-GW side terminates the received response, or the user apparatus selects the main signal termination unit (signal termination unit) according to the main signal used by the opposing apparatus (here, the apparatus on the Ph-GW side), or the main signal termination unit of the opposing apparatus (here, the apparatus on the Ph-GW side) generates a normality determination signal using the main signal, the selected main signal termination unit of the user apparatus loops back and transmits the normality determination signal, and the main signal termination unit of the opposing apparatus (here, the apparatus on the Ph-GW side) terminates the received loopback (loopback signal). In the present embodiment, the apparatus on the Ph-GW side generates the normality determination request using the control signal, in addition to the main signal normality determination request and a response thereto, or the main signal normality determination signal and its return, the opposing apparatus (here, the user apparatus) transmits the response regarding the normality determination in response to the request, the apparatus on the Ph-GW side terminates the received response or the apparatus on the Ph-GW side generates the normality determination signal, the opposing apparatus (here, the user apparatus) loops back and transmits the normality determination signal, the apparatus on the Ph-GW side terminates the received loopback (loopback signal) or the user apparatus generates the normality determination request using the control signal, the opposing apparatus (here, the apparatus on the Ph-GW side) transmits the response regarding the normality determination in response to the request, the user apparatus terminates the received response or the user apparatus generates the normality determination signal using the control signal, the opposing apparatus (here, the apparatus on the Ph-GW side) loops back and transmits the normality determination signal, and the user apparatus terminates the received loopback (loopback signal) (not shown).

A main signal termination unit (the signal termination unit) corresponding to the signal format used by the opposing apparatus may be disposed in the user apparatus. The optical cross-connect unit and the like are set so that the access network management control unit and the user apparatus can communicate. The access network management control unit selects the main signal termination unit (signal termination unit) disposed in the user apparatus. The user apparatus loops back the main signal and the control signal at the selected signal termination unit. The Ph-GW receives and terminates the looped back upstream main signal and control signal, and determines the normality.

(D1) The Ph-GW loops back, and a system configuration pattern of a plurality of main signal termination units on the Ph-GW side (“format selection+loopback side: apparatus on the Ph-GW side” and “generation, transmission, reception, and termination side: user apparatus”), the apparatus on the Ph-GW side selects the main signal termination unit (signal termination unit) according to the main signal used by the opposing apparatus (here, the user apparatus), the main signal termination unit of the opposing apparatus (here, user apparatus) generates the normality determination request using the main signal, the main signal termination unit selected by the apparatus on the Ph-GW side transmits the response regarding the normality determination in response to the request, the main signal termination unit of the user apparatus terminates the received response, or the apparatus on the Ph-GW side selects the main signal termination unit (signal termination unit) according to the main signal used by the opposing apparatus (here, the user apparatus), the main signal termination unit of the opposing apparatus (here, the user apparatus) generates a normality determination signal using that main signal, the main signal termination unit selected by the apparatus on the Ph-GW side loops back and transmits the normality determination signal, and the main signal termination unit of the opposing apparatus (user apparatus here) terminates the received loopback (loopback signal) (not shown). In the present embodiment, the apparatus on the Ph-GW side generates the normality determination request using the control signal, in addition to the main signal normality determination request and a response thereto, or the main signal normality determination signal and its return, the opposing apparatus (here, the user apparatus) transmits the response regarding the normality determination in response to the request, the apparatus on the Ph-GW side terminates the received response or the apparatus on the Ph-GW side generates the normality determination signal, the opposing apparatus (here, the user apparatus) loops back and transmits the normality determination signal, the apparatus on the Ph-GW side terminates the received loopback (loopback signal) or the user apparatus generates the normality determination request using the control signal, the opposing apparatus (here, the apparatus on the Ph-GW side) transmits the response regarding the normality determination in response to the request, the user apparatus terminates the received response or the user apparatus generates the normality determination signal using the control signal, the opposing apparatus (here, the apparatus on the Ph-GW side) loops back and transmits the normality determination signal, and the user apparatus terminates the received loopback signal (not shown).

The optical cross-connect unit or the like is set so that the access network management control unit and the user apparatus can communicate. The access network management control unit selects the termination unit for the main signal of the protocol according to the user apparatus. The access network management control unit instructs the user apparatus to generate and transmit the control signal for a normality determination. The instruction may be the control signal or the main signal. In the case of the control signal, a termination unit (the signal termination unit) according to the user apparatus may be selected after an instruction. The user apparatus modulates the upstream main signal not limited to a normality determination with an upstream control signal for a normality determination, or superimposes the upstream control signal for a normality determination on the upstream main signal, and transmits the signal in the upstream direction. The access network management control unit modulates the downstream main signal using the upstream control signal or a response thereto as a downstream control signal, or superimposes the upstream control signal or the response thereto on the downstream main signal as a downstream control signal, loops back the signal in the downstream direction, and transmits the signal. That is, the signal received by the optical IF unit 406 is looped back by the selected signal termination unit 402 and output from the optical IF unit 405.

The user apparatus receives and terminates the looped back downstream control signal, and performs a determination. With the passage of time or an instruction from the access network management control unit, the generation of the control signal for a normality determination for the user apparatus, the modulation of the upstream main signal with the generated control signal, or the superimposition of the upstream main signal is released, and a determination result is acquired from the user apparatus. The instruction may be the control signal or the main signal. The acquisition may be the control signal or the main signal. Furthermore, after the loopback is released, a connection form of the light cross-connect unit is looped back.

(D2) The PH-GW loops back, and a system configuration pattern of a plurality of main signal termination units on the user apparatus side (“format selection+generation, transmission, reception, and termination side: user apparatus” and “loopback side: apparatus on the Ph-GW side”), the user apparatus side selects the main signal termination unit (signal termination unit) according to the main signal used by the opposing apparatus (here, the apparatus on the Ph-GW side), the selected main signal termination unit generates a normality determination request using the main signal, the opposing apparatus (here, the apparatus on the Ph-GW side) transmits the response regarding the normality determination in response to the request, the selected main signal termination unit of the user apparatus terminates the received response or the user apparatus selects the main signal termination unit (signal termination unit) according to the main signal used by the opposing apparatus (here, the apparatus on the Ph-GW side), the selected main signal termination unit generates a normality determination signal using the main signal, the opposing apparatus (here, the apparatus on the Ph-GW side) loops back and transmits the normality determination signal, and the selected main signal termination unit of the user apparatus terminates the received loopback (loopback signal). In the present embodiment, the apparatus on the Ph-GW side generates the normality determination request using the control signal, in addition to the main signal normality determination request and a response thereto, or the main signal normality determination signal and its return, the opposing apparatus (here, the user apparatus) transmits the response regarding the normality determination in response to the request, the apparatus on the Ph-GW side terminates the received response or the apparatus on the Ph-GW side generates the normality determination signal, the opposing apparatus (here, the user apparatus) loops back and transmits the normality determination signal, the apparatus on the Ph-GW side terminates the received loopback (loopback signal) or the user apparatus generates the normality determination request using the control signal, the opposing apparatus (here, the apparatus on the Ph-GW side) transmits the response regarding the normality determination in response to the request, the user apparatus terminates the received response or the user apparatus generates the normality determination signal using the control signal, the opposing apparatus (here, the apparatus on the Ph-GW side) loops back and transmits the normality determination signal, and the user apparatus terminates the received loopback (loopback signal) (not shown).

A main signal termination unit (the signal termination unit) corresponding to the signal format used by the opposing apparatus may be disposed in the user apparatus. The optical cross-connect unit and the like are set so that the access network management control unit and the user apparatus can communicate. The access network management control unit selects the main signal termination unit (signal termination unit) disposed in the user apparatus. The user apparatus transmits the main signal and the control signal at the selected signal termination unit. Ph-GW loops back the main signal and the control signal. The user apparatus receives and terminates the looped back downstream main signal and the control signal, and determines the normality.

In (C1) and (D1) above, not only the control signal but also the main signal may be looped back, or only the control signal may be looped back and the main signal may be transmitted. In the latter case, a bold arrow of loopback shown in the figure (loopback) indicates that the normality determination path does not reach the UNI of the user apparatus 300, but is looped back at the multiplexing and demultiplexing unit 322, as shown in FIGS. 6 to 8, and the determination control unit 401 performs the generation and termination instead of the signal termination unit (the case of (C1)). In the case of (D1), similarly, loopback is performed in the determination control unit 401 of the access network management control unit from the control unit 330 of the user apparatus via the optical transmission path, loopback to the control unit 330 of the user apparatus is performed, and the signal does not reach the UNI of the user apparatus 300.

In FIGS. 7 and 9, a combination of “main signal loopback+control signal loopback” cannot be performed (in FIGS. 2 to 5, any one of “main signal loopback” and “a combination of main signal loopback +control signal loop” can be selected).

Regarding the access network management control unit 103, on the network side from the multiplexing and demultiplexing unit 404, the control signal is looped back or generated and terminated by the determination control unit 401, and the main signal is looped back or generated and terminated by the signal termination unit. In both cases, the multiplexing and demultiplexing unit 404 performs multiplexing. On the user side of the multiplexing and demultiplexing unit 404, when the optical IF unit is common for the control signal and the main signal, these are common, and thus, both are transmitted and received by the optical IF unit. When at least one of the transmission and reception of the optical IF unit is different between the control signal and the main signal, different transmissions or receptions, or both are performed by the optical IF units corresponding to the control signal or the main signal.

When the main signal in addition to the control signal is looped back, the control signal reception unit 331 also instructs the loopback unit 333 and UNI_PHY to execute the loopback according to the instruction.

When the loopback is performed on the Ph-GW side, the selected signal termination unit 402 loops back the signal received by the reception unit (optical IF unit), and the transmission unit (optical IF unit) outputs the signal.

Further, the main signal may be generated and terminated by the access network management control unit or may not be looped back, and only when the main signal which is modulated with the control signal or on which the control signal is superimposed by the access network management control unit is not obtained from a section opposite to the normality determination target section, the main signal may be generated, terminated, or looped back.

The determination control unit 401 selects the signal termination unit 402 according to a protocol that can be processed by the target user apparatus. The selection may be performed on the basis of information from a database inside and outside the Ph-GW or an instruction from a control system such as an APN controller, may be performed through discrimination from a signal that can be received by the signal termination unit, or may be performed on the basis of a result of an inquiry to the user apparatus. The determination control unit 401 instructs the selected signal termination unit 402 to transmit the main signal to the target user apparatus (when the Ph-GW receives the main signal for transmission confirmation from the user apparatus and performs the normality determination). The main signal may be received (when the user apparatus receives the main signal for transmission confirmation from the Ph-GW and determine the normality), or the main signal may be transmitted and received (when the main signal for transmission confirmation from the Ph-GW is looped back by the user apparatus and received by the Ph-GW, and the normality is determined using the loopback, the main signal for transmission confirmation from the user apparatus is looped back at Ph-GW, received at the user apparatus, and the normality is determined using the loopback).

There are two types of AMCC loopbacks including the entire signal including the AMCC signal and main signal, and the AMCC signal only. In the case of the entire signal, the user apparatus 300 receives only the main signal that is not affected by AMCC and loops back the signal instead of outputting the signal to the user side. Therefore, AMCC is not included in the main signal loopback. Therefore, the entire signal is looped back by receiving AMCC separately from the main signal and re-modulating the loopback of the main signal with AMCC. Therefore, in loopback of the entire signal, there are a case where the timing of the downstream main signal and the downstream AMCC signal are synchronized so that these are the same as the upstream main signal and upstream AMCC signal to be looped back, and a case where these are not synchronized.

In the case of synchronization, it is necessary to align the time from separation to the multiplexing via respective turning points of the main signal and AMCC signal regardless of the modulation scheme of the main signal. Time synchronization is performed and the AMCC modulation index is matched with the transmitting side, making it possible to send back the reproduced signal with the influence of AMCC taken into account.

In the case of non-synchronization, multiplexing can be easy. In the case of only the AMCC signal, only the AMCC control signal is sent back. In this case, since the main signal is arbitrary, a loopback test can be performed without interfering with communication of the main signal.

The ISDN example is an analogy for description. The ISDN concept is applied to the present embodiment. In ISDN, channels in the case of Basic Rate Interface (BRI) are two B channels for data communication and one D (Data) channel for communication control. Depending on a definition of a channel in the APN, for example, when the main signal and AMCC are considered as channels, a certain specific modification of one or a plurality of designated channels, for example, certain information in the AMCC signal, for example, correction according to an remote defect indication (RDI) of certain information in the AMCC signal, such as quality-related information such as an error rate, an Ack or response to a Request, or a transmission failure notification in an upstream direction may be performed and return may be performed. Quality information, RDI, or the like may be looped back not on the AMCC signal side but on the main signal side as a main signal measurement result of failure notification. The AMCC signal and the main signal may each be looped back as a plurality of channels. An example of a configuration in which the quality information is looped back is a configuration of the fourth embodiment to be described later.

### Second Modification Example of Second Embodiment

A case in which the main signal on which the control signal is superimposed cannot be used will be described.

Any one or both of the generation and termination of the main signal which is modulated with the control signal or on which the control signal is superimposed are not performed, the main signal from the apparatus on the opposite side in the normality determination target section (for example, another Ph-GW or user apparatus) may be used, and the signal termination unit of the first embodiment may be used only when the main signal is not available.

With the configuration as shown in FIGS. 6, 8, and 14, when the user apparatus looping back the control signal using a main signal from another Ph-GW or user apparatus and the opposing apparatus (for example, the other user apparatus) perform a normality determination, or when signal light continues to be passed in the user apparatus looping back the control signal using a main signal from another Ph-GW or user apparatus and the opposing apparatus (for example, the other user apparatus) and only the superimposed control signal is extracted (using a wavelength filter or the like when wavelengths are different) and terminated or only part of the split signal light is terminated, light in which at least the control signal can be received under an influence of nonlinear optical effect or the like of at least the control signal of the signal light is terminated but the main signal is transmitted, there is an effect that communication using the main signal can be continued even during the normality determination.

Any one or both of the generation and termination of the main signal which is modulated with the looped back control signal or on which the looped back control signal is superimposed are not performed, the main signal from the apparatus on the opposite side in the normality determination target section (for example, another Ph-GW or user apparatus) may be used, and the signal termination unit of the first embodiment may be used only when the main signal is not available.

With the configuration as shown in FIGS. 6, 8, and 14, when the user apparatus looping back the control signal using a main signal from another Ph-GW or user apparatus and the opposing apparatus (for example, the other user apparatus) perform a normality determination, or when signal light continues to be passed in the user apparatus generating and terminating the control signal using a main signal from another Ph-GW or user apparatus and the opposing apparatus such as the other user apparatus and only the superimposed control signal is extracted or only part of the split signal light or light in which at least the control signal is transferred due to nonlinear optical effect or the like is terminated, there is an effect that communication using the main signal can also be continued during the normality determination.

In the case of control signal loopback, since the control signal is used for the determination, the determination can be made even when the signal is the main signal that does not correspond to the protocol of the user apparatus or unmodulated light (CW light).

### Third Embodiment

FIG. 9 is a diagram showing a third embodiment of the communication system 1. The third embodiment differs from the second embodiment in that the control unit 330 further functions as the in-apparatus loopback control unit 334, and is the same as the second embodiment in most other respects. Hereinafter, the third embodiment of the communication system 1 will be described below, focusing on the differences from the second embodiment of the communication system 1.

The access network management control unit 103 transmits a control signal for instructing loopback to the user apparatus 300 (target user apparatus) connected to the section that is a signal path normality determination target. The loopback in the third embodiment corresponds to loop 2, and the normality of the path between the UNI_PHY and the MAC is also determined.

The determination control unit 401 performs the signal path normality determination processing. The determination control unit 401 outputs a control signal indicating execution of loopback and execution of in-apparatus loopback using the main signal to the optical interface unit 405. Upon receiving the control signal transmitted from the user apparatus 300, the determination control unit 401 determines the normality of the route that is a determination target on the basis of the received signal. In this case, the determination control unit 401 performs the signal path normality determination for the path including the inside of the optical transceiver 301 on the basis of the result of the in-apparatus loopback.

The user apparatus 300 includes an optical transceiver 301 and a control unit 330. Since the optical transceiver 301 of the third embodiment has the same configuration as the optical transceiver 301 of the second embodiment, except that the in-apparatus loopback is executed, description thereof will be omitted.

The control signal reception unit 331 receives from the multiplexing and demultiplexing unit 322 the control signals demultiplexed by the multiplexing and demultiplexing unit 322. The control signal reception unit 331 operates according to information indicated by the received control signal. When the control signal is information indicating an instruction to execute loopback, the control signal reception unit 331 instructs the loopback unit 333 to execute the loopback according to the instruction. When the control signal further includes information indicating an instruction to execute the in-apparatus loopback, the control signal reception unit 331 instructs the in-apparatus loopback control unit 334 to execute the in-apparatus loopback.

When receiving an instruction to execute loopback from the control signal reception unit 331, the loopback unit 333 executes loopback processing according to the instruction. A target of loopback processing in the loopback unit 333 is, for example, a control signal. The loopback processing may be implemented as a full-channel loopback, may be implemented as a partial loopback, or may be implemented as a logical loopback, for example.

The loopback unit 333 may execute loopback, for example, to show a result of executing the in-apparatus loopback. For example, the loopback unit 333 may be configured to loop back the control signal only when normal transmission is determined as a result of executing the in-apparatus loopback. In this case, the determination control unit 401 may determine that the signal path is normal in response to reception of the looped back control signal. The loopback unit 333 may be configured to include, for example, information indicating the execution result of in-apparatus loopback in the looped back control signal. In this case, the determination control unit 401 may determine whether the signal path is normal on the basis of information included in the looped back control signal. The looped back control signal is converted into an optical signal by the optical interface unit 326 and transmitted to the access network management control unit 103.

The in-apparatus loopback control unit 334 controls the optical transceiver 301 to execute in-apparatus loopback using the main signal of a protocol compatible with the optical transceiver 301 of the host apparatus. In the signal path normality determination of the optical transceiver 301 on the basis of the in-apparatus loopback, the in-apparatus loopback control unit 334 executes the in-apparatus loopback for each route, transmitter, or receiver when the main signal and the control signal pass through different routes in the optical transceiver 301, when different transmitters are used for the main signal and the control signal, or when different receivers are used for the main signal and the control signal.

FIG. 9 is a diagram showing a specific example of in-apparatus folding in the third embodiment. In the in-apparatus loopback control unit 334 of the present embodiment, when a plurality of transmitters with different specifications (for example, the main signal transmitter and a control signal transmitter) are included in the host apparatus (optical transceiver 301), in-apparatus loopback may be executed for each transmitter. The same applies to the receiver.

For example, in FIG. 9, the optical interface unit 321 includes a main signal Rx 321_1 and a control signal Rx 321_2. The main signal Rx 321_1 processes the main signal and does not process the control signal. Similarly, the control signal Rx 321_2 processes the control signal and does not process the main signal. In FIG. 9, the optical interface unit 326 includes the main signal Tx 326_1 and a control signal Tx 326_2. The main signal Tx 326_1 processes the main signal and does not process the control signal. Similarly, the control signal Tx 326_2 processes the control signal and does not process the main signal. In such a configuration, the in-apparatus loopback is executed for each of the main signal Rx 321_1 and the control signal Rx 321_2. Similarly, the in-apparatus loopback is executed for each of the main signal Tx 326_1 and the control signal Tx 326_2.

For example, a normality determination loop in the in-apparatus loopback is a loop of the multiplexing and demultiplexing unit 322, the processing unit 323, the UNI_PHY(Tx) 324, the UNI_PHY(Rx) 325, the processing unit 323, and the multiplexing and demultiplexing unit 322. For example, the normality determination loop in the in-apparatus loopback may be a loop of the processing unit 323, the UNI_PHY(Tx) 324, the UNI_PHY(Rx) 325, and the processing unit 323. For example, the normality determination loop in the in-apparatus loopback may be a loop of the processing unit 323, the multiplexing and demultiplexing unit 322, the optical interface unit 326, the optical interface unit 321, the multiplexing and demultiplexing unit 322, and the processing unit 323.

For example, the normality determination loop in the in-apparatus loopback may be a loop of the multiplexing and demultiplexing unit 322, the side where the main signal is passed in the optical interface unit 326, the side where the main signal is passed in the optical interface unit 321, and the multiplexing and demultiplexing unit 322 when at least one the light source and the reception unit of the optical IF unit is different between the main signal and the control signal. For example, the normality determination loop in the loop within the apparatus may be a loop of the control unit 330, the multiplexing and demultiplexing unit 322, the side where the main signal is passed in the optical interface unit 326, the side where the main signal is passed in the optical interface unit 321, the multiplexing and demultiplexing unit 322, and the control unit 330.

Further, when the main signal and the control signal pass through different routes, the apparatus is configured to execute the in-apparatus loopback via the respective routes.

For example, the in-apparatus loopback is executed by looping back the main signal so that the signal is input from the processing unit 323 to the processing unit 323 via the UNI_PHY (Tx) 324 and UNI_PHY (Rx) 325, and the signal path normality determination of the optical transceiver 301 may be performed. Furthermore, the in-apparatus loopback is executed by looping back the main signal so that the main signal is input from the processing unit 323 to the processing unit 323 via the multiplexing and demultiplexing unit 322, the optical interface unit 326, the optical interface unit 321, and the multiplexing and demultiplexing unit 322, and the signal path normality determination of the optical transceiver 301 may be performed. The in-apparatus loopback control unit 334 outputs the determination result of the signal path normality determination according to the execution of the in-apparatus loopback to the loopback unit 333.

A flow of signal path normality determination processing in the third embodiment will be described. At the predetermined timing, the determination control unit 401 generates the control signal for instructing execution of loopback, and outputs the control signal to the optical interface unit 405. The predetermined timing may be, for example, a timing at which a problem in communication with the user apparatus 300 is detected. The optical interface unit 405 converts the electrical signal input from the determination control unit 401 into an optical signal, and transmits the optical signal to the user apparatus 300 via the transmission path.

Upon receiving the optical signal from the access network management control unit 103, the optical interface unit 321 of the user apparatus 300 converts the received optical signal into an electrical signal and outputs the electrical signal to the multiplexing and demultiplexing unit 322. The multiplexing and demultiplexing unit 322 demultiplexes the control signal from the received signal and outputs the control signal to the control unit 330.

When the control signal reception unit 331 of the control unit 330 receives the control signal from the multiplexing and demultiplexing unit 322, the control signal reception unit 331 operates according to the content of the control included in the control signal. The control signal includes a signal indicating an instruction to execute loopback. In response to this instruction, the control signal reception unit 331 instructs the loopback unit 333 to execute the loopback of the control signal. Furthermore, the control signal reception unit 331 instructs the in-apparatus loopback control unit 334 to execute the in-apparatus loopback.

The in-apparatus loopback control unit 334 executes the in-apparatus loopback according to the instruction, and determines the normality of the signal path of the optical transceiver 301 on the basis of an execution result. The in-apparatus loopback control unit 334 outputs the determination result to the loopback unit 333. The loopback unit 333 performs loopback processing on the received control signal according to a determination result of the in-apparatus loopback control unit 334. By executing the loopback process, the loopback unit 333 outputs the control signal to the multiplexing and demultiplexing unit 322.

The looped back control signal is converted into an electrical signal by the optical interface unit 406, and is input to the determination control unit 401, which has been the transmission source of the control signal. The determination control unit 401 performs a predetermined evaluation on the input control signal according to the transmission confirmation. For example, the evaluation may be made regarding whether or not the loopback has been performed correctly, or the evaluation may be made regarding the execution result of in-apparatus loopback. The determination control unit 401 performs the signal path normality determination regarding the target user apparatus on the basis of the evaluation result. The determination control unit 401 may output the determination result to another apparatus or record the determination result in a storage apparatus as a log.

According to the communication system 1 of the third embodiment configured in this way, a control signal that can be processed by the user apparatus 300 is transmitted to the user apparatus 300. Therefore, it is possible to perform the loopback at the loopback point (loopback unit 333) after the main signal passes through the path after optical-to-electrical conversion in the optical transceiver 301.

Therefore, it is possible to determine the normality of the signal path including the inside of the user apparatus 300 in a protocol-independent APN that does not depend on a specific communication protocol or modulation scheme.

Furthermore, according to the communication system 1 of the third embodiment, the in-apparatus loopback is executed in the optical transceiver 301 of the user apparatus 300, and the signal path normality is determined for the signal path within the apparatus. For example, the normality of the signal paths in the processing unit 323, UNI_PHY(Tx) 324, UNI_PHY(Rx) 325, and processing unit 323 is determined. In this case, since the signal is looped back within the apparatus, processing using a signal of a protocol that can be processed by the optical transceiver 301 is naturally performed. Therefore, in the protocol-independent APN that does not depend on a specific communication protocol or modulation scheme, it is possible to determine the normality of the signal path including the inside of the user apparatus 300 (in particular, apparatus that depends on protocols such as MAC and UNI_PHY). Such processing is superior to other signal path normality determination, similar to the second embodiment described above.

The normality determination may be made by a transmission confirmation or a self-diagnosis function, which is not limited to loopback. In order to avoid a situation where it is possible to only determine whether or not the transmission path is normal until a test signal is looped back at the turning point, a self-diagnosis function for a portion not related to a test signal transmission path (a portion through which the test signal does not flow) may be provided.

For example, a means for creating a test signal when a test start request or a test start response to the test start request is received (in the case of the transmission and reception side) and transmitting the test signal via an optical transmission path, a means for receiving the test signal via the optical transmission path, a means for receiving a result of the self-diagnosis function, and a means for transmitting a test termination request via the optical transmission path when the result of the self-diagnosis function is received are included.

A means for receiving the test signal via the optical transmission path when a test start request or a test start response to the test start request is received (on the loopback side), a means for receiving a result of the self-diagnosis function, and a means for creating a response signal or loopback signal when result of the self-diagnosis function is received and transmitting the signal via an optical transmission path are included (transmission of the response or loopback signal may be separate from the self-diagnosis result. Even when this is not come out separately, when an error is detected by using the self-diagnosis function, it is preferable to transmit data for identifying an error location.)

The self-diagnosis function is also not limited to test signal loopback. When the self-diagnosis function is test signal loopback, for example, a loopback switch that directly connects the signal from the reception unit of the transmission and reception unit directly to the transmission unit is provided in advance, and the self-diagnosis function is turned on and off under control, the self-diagnosis function is set so that the signal is looped back only at the time of the loopback test. For example, a section of a AAL5 termination unit to the UNI in the case of transmission using ATM, and a section from UNI of a client signal that exchanges a client signal transmitted using the OTN frame in the apparatus in the case of transmission using the OTN frame with the user side to a framer that incorporates a client signal into the OTN frame correspond to this. The payload in ATM used in the test, the pseudo-random pattern included in an OTN client signal, or the like may be generated within the apparatus, or may be generated by the opposing apparatus, cut out, and used within the apparatus.

When the test signal is not looped back, the determination may be made using the self-diagnosis function of each circuit through which the signal does not pass. For example, in the case of a frame buffer, only a small portion of the memory area is used for looped back test signal data such as frame data. In most areas, since the test signal uses only a small portion of the memory area, it is not possible to find an error in most parts of the frame buffer only by a loopback test. Therefore, a read/write test of the memory constituting the buffer is performed as self-diagnosis.

As described above, for example, the second user apparatus (user apparatus 300-2) uses a predetermined signal inside the second user apparatus to further determine (self-diagnose) whether the inside of the second user apparatus is normal, in addition to determining whether the signal path is normal.

### Fourth Embodiment

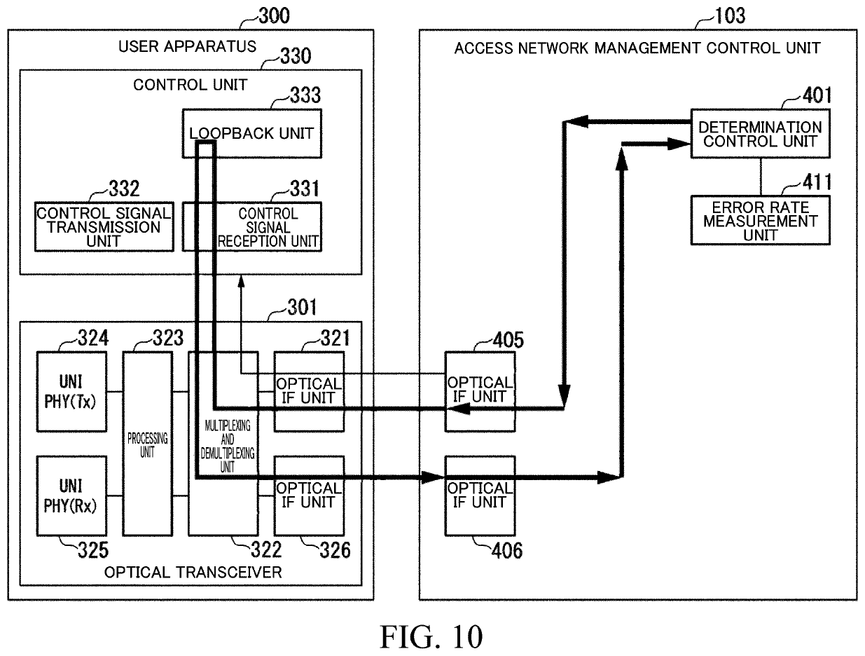

FIG. 10 is a diagram showing a fourth embodiment of the communication system 1. The fourth embodiment differs from the second embodiment in that the access network management control unit 103 further includes an error rate measurement unit 411, and is the same as the second embodiment in most other respects. Hereinafter, the fourth embodiment of the communication system 1 will be described, focusing on the differences from the second embodiment of the communication system 1.

The access network management control unit 103 transmits a control signal for instructing loopback to the user apparatus 300 (target user apparatus) connected to the section that is a signal path normality determination target.

The error rate measurement unit 411 generates a signal for measuring the error rate and outputs the signal to the determination control unit 401. The signal for measuring the error rate may be generated using any scheme. For example, the signal for measuring the error rate may be generated as a Pseudo-Random Binary Sequence (PRBS) pattern. The error rate measurement unit 411 measures the error rate on the basis of the control signal looped back in user apparatus 300. The error rate measurement unit 411 outputs the measurement result to the determination control unit 401.

The determination control unit 401 performs signal path normality determination processing. The determination control unit 401 outputs a control signal indicating execution of loopback to the optical interface unit 405. Upon receiving the control signal transmitted from the user apparatus 300, the determination control unit 401 outputs the received signal to the error rate measurement unit 411. The determination control unit 401 determines the normality of the route that is a determination target on the basis of the received signal and the measurement result in the error rate measurement unit 411.

Since the user apparatus 300 has the same configuration as the second embodiment, description thereof will be omitted. A flow of signal path normality determination processing in the fourth embodiment will be described. At the predetermined timing, the error rate measurement unit 411 generates the signal for measuring the error rate and outputs the signal to the determination control unit 401. The determination control unit 401 generates the control signal for instructing execution of loopback, and outputs the control signal to the optical interface unit 405. This control signal includes the signal for measuring the error rate. The predetermined timing may be, for example, a timing at which a problem in communication with the user apparatus 300 is detected. The optical interface unit 405 converts the electrical signal input from the determination control unit 401 into an optical signal, and transmits the optical signal to the user apparatus 300 via the transmission path.

Since the operation in the user apparatus 300 is the same as that in the second embodiment, description thereof will be omitted. The control signal looped back in the user apparatus 300 is converted into an electrical signal in the optical interface unit 406. The error rate measurement unit 411 measures the error rate on the basis of the received signal. The error rate measurement unit 411 outputs the measurement result to the determination control unit 401. The determination control unit 401 performs a predetermined evaluation on the input control signal according to the transmission confirmation. For example, an evaluation may be made as to whether the loopback has been performed correctly. The determination control unit 401 performs the signal path normality determination regarding the target user apparatus on the basis of the evaluation result. Even when loopback is performed correctly, the determination control unit 401 may determine that the signal path is abnormal when a predetermined condition indicating that the error rate is poor is satisfied. The determination control unit 401 may output the determination result to another apparatus or record the determination result in a storage apparatus as a log.

According to the communication system 1 of the fourth embodiment configured in this way, a control signal that can be processed by the user apparatus 300 is transmitted to the user apparatus 300. Therefore, it is possible to perform the loopback at the loopback point (loopback unit 333) after the main signal passes through the path after optical-to-electrical conversion in the optical transceiver 301. Therefore, it is possible to determine the normality of the signal path including the inside of the user apparatus 300 in a protocol-independent APN that does not depend on a specific communication protocol or modulation scheme.

Furthermore, according to the communication system 1 of the fourth embodiment, the error rate is measured on the basis of the control signal. Therefore, it is possible to determine the normality of the signal path also from the viewpoint of the error rate.

### Modification Example

The user apparatus 300 of the fourth embodiment may be configured to further include the in-apparatus loopback control unit 334 of the third embodiment. In this case, in loopback of the control signal, the in-apparatus loopback control unit 334 instructs the optical transceiver 301 to execute in-apparatus loopback. The loopback unit 333 may execute loopback to show a result of executing the in-apparatus loopback. The determination control unit 401 may determine the normality of the signal path on the basis of the measurement result of the error rate and the execution result of in-apparatus loopback.

The user apparatus 300 of the fourth embodiment may have the same configuration as the error rate measurement unit 411. In this case, the user apparatus 300 may measure the error in the downstream direction by measuring the downstream signal from the Ph-GW 100-2.

The user apparatus 300 of the fourth embodiment may include a pseudo-random number generator. In this case, the user apparatus 300 may transmit an upstream signal containing a random number generated by a pseudo-random number generator to the Ph-GW 100-2, and an error rate measurement unit 411 of the Ph-GW 100-2 may measure the error to measure an upward error. The Ph-GW 100-2 may include both a pseudo-random number generator and an error rate determination unit. In this case, downstream, loopback, and upstream errors may be measured.

The user apparatus 300 may include both a pseudo-random number generator and an error rate measurement unit to measure upstream, loopback, and downstream errors.

In the fourth embodiment, among processing performed by the error rate measurement unit 411, processing of measuring the error rate may be executed in the user apparatus 300.

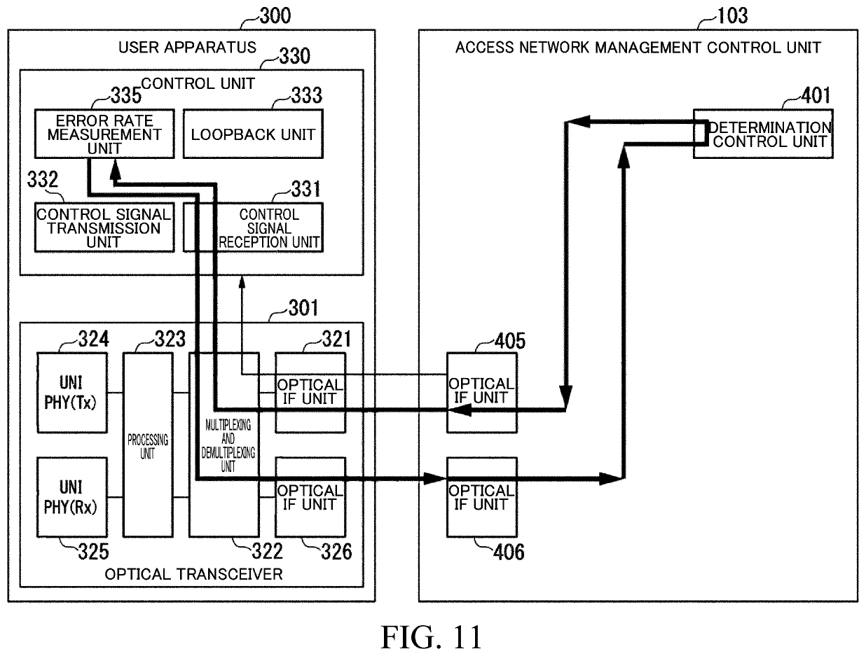

FIG. 11 is a diagram showing a second example of a configuration of the communication system 1 in the fourth embodiment. In this case, the control unit 330 of the user apparatus 300 includes an error rate measurement unit 335. A measurement result of the error rate measurement unit 335 is transmitted to the determination control unit 401 of the access network management control unit 103. The determination control unit 401 performs a determination on the basis of the measurement result of the error rate measurement unit 335.

As described above, for example, when the second user apparatus (user apparatus 300-2) does not transmit the control signal or main signal indicating the signal for measuring the error rate to the second control apparatus, the second control apparatus (access network management control unit 103-2) transmits the control signal or main signal indicating the signal for measuring the error rate to the second user apparatus, and determines whether the signal path is normal further on the basis of the measurement result of the error rate based on the control signal or main signal looped back by the second user apparatus.

For example, when the second user apparatus (user apparatus 300-2) transmits the control signal or main signal indicating the signal for measuring the error rate to the second control apparatus, the second control apparatus (access network management control unit 103-2) may determine whether the signal path is normal further on the basis of the error rate measurement result based on the control signal or main signal transmitted from the second user apparatus.

### Fifth Embodiment

FIG. 12 is a diagram showing a fifth embodiment of the communication system 1. In the fifth embodiment, the access network management control unit 103 includes an FEC determination control unit 412. The access network management control unit 103 may include an FEC determination control unit 412 instead of the determination control unit 401. The fifth embodiment differs from the second embodiment in that the control unit 330 of the user apparatus 300 further includes an FEC switching unit 336, and is the same as the second embodiment in most of other respects. Hereinafter, the fifth embodiment of the communication system 1 will be described below, focusing on differences from the second embodiment of the communication system 1.

The access network management control unit 103 transmits a control signal for instructing loopback to the user apparatus 300 (target user apparatus) connected to the section that is a signal path normality determination target.

The FEC determination control unit 412 generates a control signal indicating execution of loopback, and adds a forward error correction (FEC) error correction code to the control signal. The FEC determination control unit 412 performs the signal path normality determination processing by transmitting a control signal to which an FEC error correction code is assigned, to the user apparatus 300. The FEC determination control unit 412 outputs the control signal generated by the above-described processing to the optical interface unit 405.

Upon receiving the looped back control signal from the user apparatus 300, the FEC determination control unit 412 determines the normality of the route that is a determination target on the basis of the received signal. For example, the FEC determination control unit 412 determines the normality of the path on the basis of whether or not predetermined processing is performed on the control signal in the user apparatus 300. As a specific example of the predetermined processing, processing for newly generating an error correction code using a different encoding scheme from an encoding scheme used by the FEC determination control unit 412, and assigning the new error correction code to the control signal is possible. Further, as another specific example of the predetermined processing, processing for assigning the same error value to the control signal in the user apparatus 300 is possible when the FEC determination control unit 412 assigns an error correction code to the control signal and intentionally assigns an error value to a numerical value within a range in which error correction can be performed with the error correction code.

When receiving an instruction to execute loopback from the control signal reception unit 331, the FEC switching unit 336 of the control unit 330 of the user apparatus 300 executes loopback processing according to the instruction. A target of the loopback processing in the FEC switching unit 336 is, for example, a control signal including an error correction code. The FEC switching unit 336 generates a control signal for loopback by performing the predetermined processing described above. The FEC switching unit 336 outputs the generated control signal to the multiplexing and demultiplexing unit 322. The looped back control signal is converted into an optical signal by the optical interface unit 326 and transmitted to the access network management control unit 103.

A flow of signal path normality determination processing in the fifth embodiment will be described. At the predetermined timing, the FEC determination control unit 412 generates a control signal for instructing loopback, and assigns an error correction code to the control signal. The predetermined timing may be, for example, a timing at which a problem in communication with the user apparatus 300 is detected. The optical interface unit 405 converts the electrical signal input from FEC determination control unit 412 into an optical signal, and transmits the optical signal to the user apparatus 300 via the transmission path.

Upon receiving the optical signal from the access network management control unit 103, the optical interface unit 321 of the user apparatus 300 converts the received optical signal into an electrical signal and outputs the electrical signal to the multiplexing and demultiplexing unit 322. The multiplexing and demultiplexing unit 322 demultiplexes the control signal from the received signal and outputs the control signal to the control unit 330.

When the control signal reception unit 331 of the control unit 330 receives the control signal from the multiplexing and demultiplexing unit 322, the control signal reception unit 331 operates according to the content of the control included in the control signal. The control signal includes a signal indicating an instruction to execute loopback. In response to this instruction, the control signal reception unit 331 instructs the FEC switching unit 336 to execute the control signal loopback. The FEC switching unit 336 generates a control signal that is looped back to the access network management control unit 103 by executing predetermined processing on the received control signal. The FEC switching unit 336 outputs the generated control signal to the multiplexing and demultiplexing unit 322.

The control signal looped back in the user apparatus 300 is converted into an electrical signal in the optical interface unit 406. The FEC determination control unit 412 determines whether or not predetermined processing is performed on the control signal in the user apparatus 300 on the basis of the received signal. The FEC determination control unit 412 determines the normality of the route according to a determination result. The FEC determination control unit 412 may output the determination result to another apparatus or record the determination result in a storage apparatus as a log.

According to the communication system 1 of the fifth embodiment configured in this way, a control signal that can be processed by the user apparatus 300 is transmitted to the user apparatus 300. Therefore, it is possible to perform loopback at a loopback point (FEC switching unit 336) after the main signal passes through the path after optical-to-electrical conversion in the optical transceiver 301. Therefore, it is possible to determine the normality of the signal path including the inside of the user apparatus 300 in a protocol-independent APN that does not depend on a specific communication protocol or modulation scheme.

The user apparatus 300 of the fifth embodiment may be configured to further include the in-apparatus loopback control unit 334 of the third embodiment. In this case, in loopback of the control signal, the in-apparatus loopback control unit 334 instructs the optical transceiver 301 to execute in-apparatus loopback. The FEC switching unit 336 may execute loopback to show a result of executing the in-apparatus loopback. The FEC determination control unit 412 may further determines the normality of the signal path on the basis of the execution result of the in-apparatus loopback, in addition to whether or not predetermined processing is performed on the control signal in the user apparatus 300.

As described above, for example, the second control apparatus (access network management control unit 103-2) transmits the control signal to which the error correction code is assigned to the second user apparatus (user apparatus 300-2), and determines whether the signal path is normal further on the basis of whether predetermined processing has been performed on the control signal looped back from the second user apparatus (user apparatus 300-2).

### Sixth Embodiment

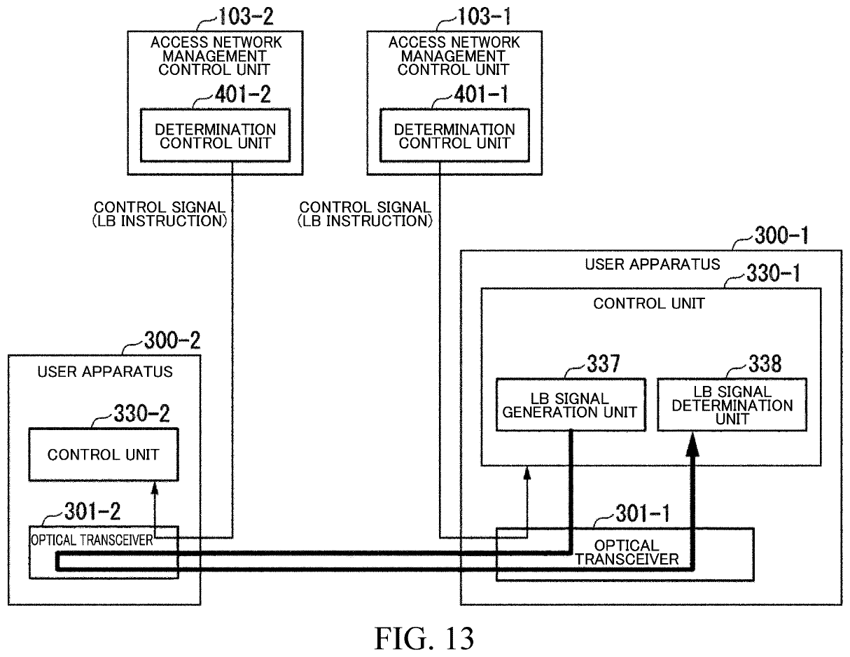

FIG. 13 is a diagram showing a sixth embodiment of the communication system 1. In the sixth embodiment, each access network management control unit 103 sends an instruction regarding loopback execution to the user apparatus 300 connected to the host apparatus (Ph-GW 100). This instruction is performed using the control signal such as AMCC. In response to this control signal, loopback is performed in communication between the user apparatuses 300, so that the signal path normality determination is performed on the path between the user apparatuses 300.

The determination control unit 401-1 of the access network management control unit 103-1 transmits a control signal for loopback execution to the user apparatus 300-1 connected to the section that is a signal path normality determination target. With this control signal, an instruction to generate the main signal for loopback and transmit the main signal to the user apparatus 300-2 is performed.

The determination control unit 401-2 of the access network management control unit 103-2 transmits a control signal for loopback execution to the user apparatus 300-2 connected to the section that is a signal path normality determination target. With this control signal, an instruction to receive the main signal for loopback and perform loopback is performed.

The user apparatus 300-1 includes an optical transceiver 301-1 and a control unit 330-1. The control unit 330-1 includes an LB signal generation unit 337 and an LB signal determination unit 338.

Upon receiving the loopback instruction from the determination control unit 401-1, the LB signal generation unit 337 transmits the main signal of a protocol that can be processed by the user apparatus 300-2.

Upon receiving the main signal looped back from the opposing user apparatus 300-2, the LB signal determination unit 338 performs a predetermined evaluation on the received main signal according to the transmission confirmation. For example, an evaluation may be made as to whether the loopback has been performed correctly. The LB signal determination unit 338 outputs information indicating the evaluation result to the determination control unit 401.

A flow of signal path normality determination processing in the sixth embodiment will be described. At the predetermined timing, the determination control unit 401-1 instructs the user apparatus 300-1, which is one of target user apparatuses, to output the main signal for loopback using the control signal. At the predetermined timing, the determination control unit 401-2 instructs the user apparatus 300-2, which is the other target user apparatus, to execute loopback using the control signal. The predetermined timing may be, for example, a timing at which a problem in communication with the user apparatus 300 is detected.

Upon receiving the instruction, the LB signal generation unit 337 of the user apparatus 300-1 generates the main signal for loopback and outputs the main signal to the optical transceiver 301-1. The optical transceiver 301-1 converts the main signal into an optical signal and transmits the optical signal to the user apparatus 300-2 via the Ph-GW 100-1 and the Ph-GW 100-2.

The control unit 330-2 of the user apparatus 300-2 instructs the optical transceiver 301-2 of the user apparatus 300-2 to perform main signal loopback in response to reception of a control signal indicating loopback execution from the access network management control unit 103-2. Upon receiving an optical signal from the opposing user apparatus 300-1, the optical transceiver 301-2 converts the received optical signal into an electrical signal. The optical transceiver 301-2 loops back the main signal within the optical transceiver 301-2. In this case, the processing unit 323 may serve as a loopback point to execute loopback processing, or the UNI_PHY(Tx) 324 or UNI_PHY(Rx) 325 may serve as a loopback point to execute loopback processing. The optical transceiver 301-2 converts the looped back main signal into an optical signal and transmits the optical signal to the user apparatus 300-1 via the Ph-GW 100-2 and Ph-GW 100-1.

The looped back main signal is converted into an electrical signal by the optical transceiver 301-1 and input to the LB signal determination unit 338. The LB signal determination unit 338 performs a predetermined evaluation on the input main signal according to the transmission confirmation. For example, an evaluation may be made as to whether the loopback has been performed correctly. The LB signal determination unit 338 transmits information indicating the evaluation result to the access network management control unit 103-1. The determination control unit 401-1 of the access network management control unit 103-1 performs the signal path normality determination regarding the signal path between the user apparatuses 300 on the basis of the evaluation result received from the LB signal determination unit 338. The determination control unit 401-1 may output the determination result to another apparatus or record the determination result in a storage apparatus as a log.

According to the communication system 1 of the sixth embodiment configured in this way, each user apparatus 300 connected to the path that is the signal path normality determination target is instructed to execute the loopback using the control signal from the access network management control unit 103. The control signal used here is a control signal that can be processed by each user apparatus 300. Furthermore, the main signal that is a loopback target is transmitted from one user apparatus 300 (300-1) to the other user apparatus 300 (300-2) using a signal of a protocol that can be processed by the user apparatus 300. Therefore, it is possible to perform the loopback at a loopback point after the main signal passes through the path after optical-to-electrical conversion in the optical transceiver 301. Therefore, it is possible to determine the normality of the signal path including the inside of the user apparatus 300 in a protocol-independent APN that does not depend on a specific communication protocol or modulation scheme.

### Modification Example of Sixth Embodiment

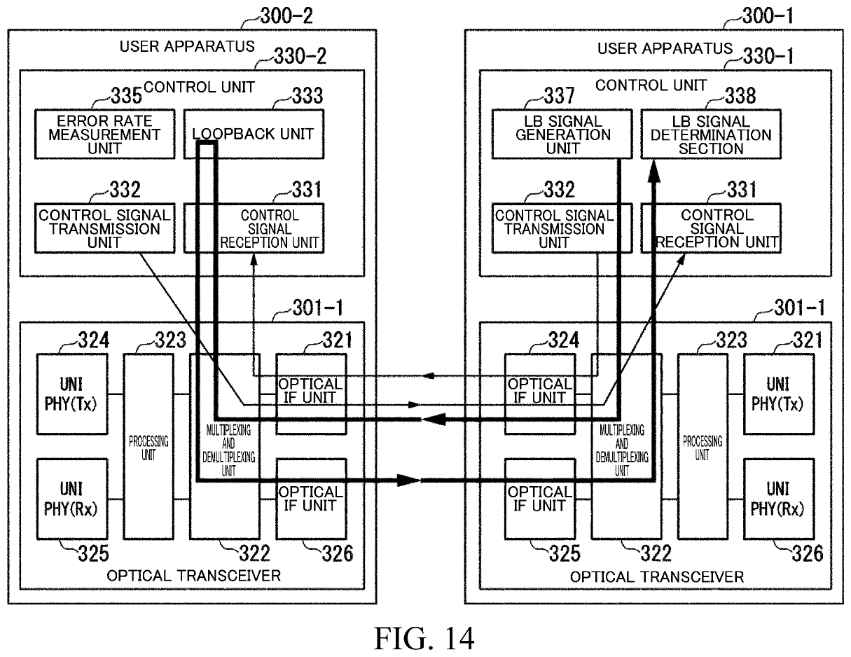

FIG. 14 is a diagram showing a modification example of the sixth embodiment. In the example of FIG. 13 described above, in the user apparatus 300-2, loopback is executed in the optical transceiver 301-2 without going through the control unit 330-2. On the other hand, as shown in FIG. 14, the loopback may be executed via the control unit 330-2 in the user apparatus 300-2. However, in this case, the signal that is a loopback target is the control signal.

The control signal transmission unit 332 of the user apparatus 300-1 transmits an instruction signal for instructing loopback to the control signal reception unit 331 of the user apparatus 300-2. The control signal transmission unit 332 of the user apparatus 300-2 transmits an instruction signal for instructing loopback to the control signal reception unit 331 of the user apparatus 300-1.

The LB signal generation unit 337 and the LB signal determination unit 338 do not necessarily need to be provided in the user apparatus 300-1. For example, the LB signal generation unit 337 and the LB signal determination unit 338 may be provided in the Ph-GW 100-1, a communication apparatus (not shown; relay apparatus), or the like. In this case, the apparatus that receives the control signal for loopback execution from the access network management control unit 103-1 is a communication apparatus that includes the LB signal generation unit 337 and the LB signal determination unit 338.

In the sixth embodiment, the one user apparatus 300 (300-1) may include a pseudo-random number generator, and the other user apparatus 300 (300-2) may include an error rate determination unit. In this case, the one user apparatus 300 may transmit a signal containing the random number generated by the pseudo-random number generator to the opposing user apparatus 300 (the other user apparatus), and the error rate measurement unit 411 of the other user apparatus 300 may measure an error to measure the error in a direction from the one user apparatus 300 to the other user apparatus 300. The one user apparatus 300 (300-1) may include both a pseudo-random number generator and an error rate determination unit. In this case, downstream, loopback, and upstream errors for one user apparatus 300 may be measured.

As described above, FIGS. 2 to 5 show a determination of normality of a signal path including the inside of the user apparatus that transmits and receives optical signals (main signals) of various protocols (transmission path section+at least part of the user apparatus)”, and FIGS. 2 to 8 show a determination of normality of a path (transmission path section) of the optical signal (main signal) by the control signal superimposed on the optical signal (main signal) or modulating the optical signal (main signal).

The communication system having a configuration (substructure) illustrated in each of FIGS. 2 to 5 selects whether the protocol of the main signal transmitted and received by the user apparatus can be terminated as a normal signal by receiving an instruction from the APN controller, information of the DB, or the acquisition or the main signal from the user apparatus in the transparent network that transmits main signals of various protocols, generates and terminates the optical signal of the selected protocol, and transmits the optical signal to the user apparatus, terminates the signal looped back by the user apparatus, or loops back the signal transmitted from the user apparatus to the user apparatus, and the user apparatus terminates the signal, and determines the normality (a range of normality determination of the route inside the user apparatus is broader when the user apparatus performs loopback)

Alternatively, the communication system having a configuration (main configuration) illustrated in each of FIGS. 6 to 8 determines the normality through the loopback of the control signal that is independent of the protocol of the main signal used in the transparent network that transmits main signals of various protocols.

Alternatively, a communication system that is a combination of the configuration illustrated in each of FIGS. 2 to 5 (secondary configuration) and the configuration illustrated in each of FIGS. 6 to 8 (main configuration) selects whether the protocol of the main signal transmitted and received by the user apparatus can be terminated as a normal signal by receiving an instruction from the APN controller, information of the DB, or the acquisition or the main signal from the user apparatus in the transparent network that transmits main signals of various protocols, generates and terminates the optical signal of the selected protocol, and determines the normality through the loopback of the control signal that is independent of the protocol of the main signal used in a transparent network in that state.

A communication system illustrated in FIGS. 13 and 14 is a communication system including a first apparatus and a second apparatus that communicate with each other using optical signals, wherein the first apparatus transmits the control signal to the second apparatus using the optical signal, the second apparatus loops back the control signal or a response thereto to the first apparatus, and the first apparatus receives the looped back control signal or a response thereto, and determines whether or not a signal path including a signal path between the first apparatus and the second apparatus is normal.

In the communication system illustrated in FIG. 13, the first control apparatus (the access network management control unit 103-1) transmits the first control signal to instruct a loopback (an instruction signal indicating loopback instruction) to the first user apparatus. The second control apparatus (access network management control unit 103-2) transmits the second control signal to instruct loopback (an instruction signal indicating a loopback instruction) to the second user apparatus. The second user apparatus loops back the main signal transmitted from the first user apparatus. The first user apparatus determines whether the signal path including a section between the first user apparatus and the second user apparatus is normal on the basis of the looped back main signal.

In the communication system illustrated in FIG. 14, the second user apparatus transmits the instruction signal indicating the loopback instruction to the first user apparatus. The second user apparatus loops back the control signal transmitted from the first user apparatus. The first user apparatus transmits the instruction signal indicating the loopback instruction to the second user apparatus. The first user apparatus determines whether the signal path including a section between the first user apparatus and the second user apparatus is normal on the basis of the looped back control signal.

The normality determination method executed by the communication system illustrated in FIGS. 13 and 14 is a communication method performed by a communication system including a first apparatus and a second apparatus that communicate with each other using optical signals, and includes a step in which the first apparatus transmits the control signal to the second apparatus using an optical signal; a step in which the second apparatus loops back the control signal or the response thereto to the first apparatus; and a step in which the first apparatus receives the looped back control signal or the response thereto and determines whether or not the signal path including the signal path between the first apparatus and the second apparatus is normal.

The communication system illustrated in each of FIGS. 2 to 5 is a communication system including a first apparatus and a second apparatus facing each other and transmitting and receiving optical signals, wherein the first apparatus selectively generates an optical signal in a format that can be transmitted or received by the second apparatus, transmits the generated optical signal to the opposing second apparatus, the second apparatus loops back and transmits the received optical signal or a response thereto, and the first apparatus receives the looped back optical signal or a response thereto and determines whether or not the signal path including the signal path between the first apparatus and the second apparatus is normal from the received looped back optical signal or the response thereto.

In the communication systems illustrated in each of FIGS. 2 to 5, the user apparatus 300 loops back the main signal transmitted from the control apparatus (access network management control unit) that generates and terminates the main signal. The control apparatus determines whether or not the signal path including the section between the control apparatus and the user apparatus is normal on the basis of the looped back main signal.

In the communication systems illustrated in each of FIGS. 2 to 5, the control apparatus (access network management control unit) may loop back the main signal transmitted from the user apparatus. The user apparatus may determine whether the signal path including a section between the user apparatus and the control apparatus that generates and terminates the main signal is normal, on the basis of the looped back main signal.

In the communication systems illustrated in each of FIGS. 2 to 5, when the control apparatus (access network management control unit) executes the determination, the control apparatus may multiplex the control signal with the main signal to determine whether or not he signal path is normal on the basis of the control signal. The control apparatus may multiplex the control signal on an input optical signal different from the main signal, and determine whether the signal path is normal, on the basis of the control signal multiplexed on the input optical signal. The input optical signal is an input optical signal, for example, unmodulated continuous light. The input optical signal is an optical signal that does not depend on the form of the main signal used by the user apparatus. Further, optical power of the input optical signal is adjusted, for example, and the input optical signal does not destroy an apparatus (user apparatus, or the like) on the receiving side.

The communication system illustrated in each of FIGS. 2 to 8 is communication system including a first apparatus and a second apparatus that superimposes the control signal on the optical signal of the host apparatus or the optical signal from the other apparatus or modulates the optical signal of the host apparatus or the optical signal from the other apparatus to transmit the optical signal, wherein the first apparatus and the second apparatus are apparatuses facing each other, the first apparatus generates an optical signal in a format that can be transmitted and received by the second apparatus, and transmits a control signal superimposed on the generated optical signal or modulating the generated optical signal to the second apparatus, the second apparatus Superimposes the control signal on the optical signal of the host apparatus or the optical signal from the other apparatus or modulates the optical signal or the optical signal from another apparatus and loops back and transmits the received control signal or a response thereto, and the first apparatus superimposes the control signal on the optical signal or modulates the optical signal, receives the looped back control signal or the response thereto, and determines whether or not a signal path including the signal path between the first apparatus and the second apparatus is normal from the received looped back control signal or the response thereto.

The communication system illustrated in each of FIGS. 6 to 8 is a communication system including a first apparatus and a second apparatus that superimposes the control signal on the optical signal of the host apparatus or the optical signal from the other apparatus or modulates the optical signal of the host apparatus or the optical signal from the other apparatus to communicate the control signal, the first apparatus transmits a control signal superimposed on the optical signal of the host apparatus or the optical signal from another apparatus or modulating the optical signal of the host apparatus or the optical signal from the other apparatus to the second apparatus, the second apparatus superimposes the control signal on the optical signal of the host apparatus or the optical signal from the other apparatus or modulates the optical signal of the host apparatus or the optical signal from the other apparatus and loops back and transmits the received control signal or a response thereto, and the first apparatus receives the control signal superimposed on the optical signal or obtained by modulating the optical signal and determines whether or not the signal path including the signal path between the first apparatus and the second apparatus is normal from the received looped back control signal or a response thereto.

In the communication systems illustrated in FIGS. 6 to 8, the user apparatus 300 loops back the control signal transmitted from the control apparatus (access network management control unit). The control apparatus determines whether the signal path including the section between the control apparatus and the user apparatus is normal on the basis of the looped back control signal.

In the communication system illustrated in FIG. 9, the user apparatus 300 may execute loopback of a predetermined signal inside the user apparatus and further determine whether the inside of the user apparatus is normal, in addition to determining whether the signal path is normal.

### Hardware Configuration Example

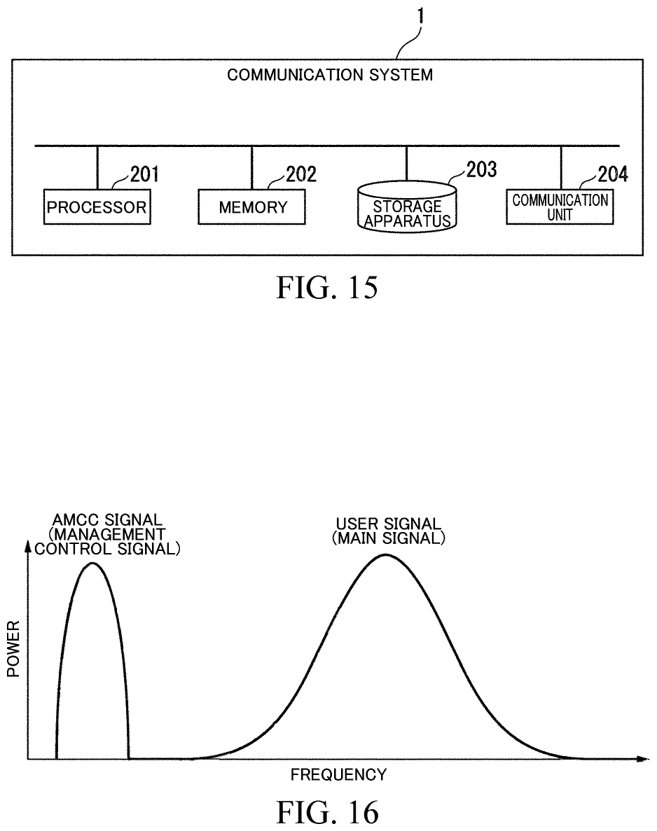

FIG. 15 is a diagram showing an example of a hardware configuration of the communication system 1 in the embodiment. Some or all of functional units of the communication system 1 are realized as software by a processor 201 such as a CPU executing a program stored in a storage apparatus 203 having a non-volatile recording medium (non-temporary recording medium) and a memory 202. For example, the determination control unit 401 or the control unit 330 described above may be configured using the processor 201 such as a CPU and the nonvolatile recording medium. The program may be recorded on a computer-readable non-transitory recording medium. The computer-readable non-transitory recording medium is a non-temporary recording medium such as a portable medium such as a flexible disk, a magneto-optical disc, a read only memory (ROM), or a compact disc read only memory (CD-ROM), or a storage apparatus such as a hard disk built into a computer system. A communication unit 204 executes predetermined communication processing. The communication unit 204 may acquire data of an optical signal transmitted through an optical fiber (for example, main signal data or wavelength data), and a program.

Some or all of the functional units of the communication system 1 may be realized using hardware including an electronic circuit or circuitry using, for example, a large scale integrated circuit (LSI), an application specific integrated circuit (ASIC), a programmable logic device (PLD), or a field programmable gate array (FPGA).

The respective embodiments may be combined.

Although the embodiments of the present invention have been described above in detail with reference to the drawings, a specific configuration is not limited to these embodiments, and includes, for example, design within the scope of the gist of the present invention.

### INDUSTRIAL APPLICABILITY

The present invention is applicable to a communication system that communicates using a communication network such as an all-photonics network (APN).

### REFERENCE SIGNS LIST

1 Communication system
100 Ph-GW
101 Optical cross-connect unit
102 Wavelength multiplexing and demultiplexing unit
103 Access network management control unit
200 APN controller
201 Processor
202 Memory
203 Storage apparatus
204 Communication unit
300 User apparatus
301 Optical transceiver
321, 326 Optical interface unit
322 Multiplexing and demultiplexing unit
323 Processing unit
324 UNI_PHY(Tx)
325 UNI_PHY(Rx)
330 Control unit
331 Control signal reception unit
332 Control signal transmission unit
333 Loopback unit
334 In-apparatus loopback control unit
335 Error rate measurement unit
336 FEC switching unit
337 LB signal generation unit
338 LB signal determination unit
401 Determination control unit
402 Signal termination unit
403 SW
404 Multiplexing and demultiplexing unit
405, 406 Optical interface unit
411 Error rate measurement unit
412 FEC determination control unit

1. A communication system comprising one or more control apparatuses and one or more user apparatuses, wherein
a first user apparatus or first control apparatus responds with a second control signal to a first control signal transmitted from an opposing second user apparatus or second control apparatus,
the second user apparatus or second control apparatus determines whether a signal path including sections between the first user apparatus or first control apparatus and the second user apparatus or second control apparatus is normal on the basis of the second control signal used in the response,
or
the first user apparatus or first control apparatus loops back the first control signal transmitted from the opposing second user apparatus or second control apparatus, and
the second user apparatus or second control apparatus determines whether a signal path including the section between the first user apparatus or first control apparatus and the second user apparatus or second control apparatus is normal on the basis of the looped back first control signal.

2. The communication system according to claim 1, wherein the first control apparatus multiplexes the second control signal on another optical signal different from the main signal when the optical signal for carrying the second control signal does not reach the first control apparatus or multiplexes the second control signal on the optical signal for carrying the second control signal when the optical signal for carrying the second control signal reaches the control apparatus, and determines whether the signal path is normal on the basis of the second control signal multiplexed on the other optical signal or the optical signal.

3. A communication system comprising one or more control apparatuses and one or more user apparatuses, wherein
a first user apparatus or first control apparatus loops back a first main signal transmitted from a second user apparatus or second control apparatus that generates and terminates a main signal in a signal format selected on the basis of a signal format used by an opposing second user apparatus or second control apparatus,
the second user apparatus or second control apparatus determines whether a signal path including sections between the second user apparatus or second control apparatus and the first user apparatus or first control apparatus is normal on the basis of the looped back first main signal,
or
the first user apparatus or first control apparatus loops back the second main signal transmitted from the second user apparatus or second control apparatus in a signal format selected on the basis of a signal format used by the opposing second user apparatus or second control apparatus,
the second user apparatus or second control apparatus determines whether a signal path including sections between the second user apparatus or second control apparatus and the first user apparatus or first control apparatus is normal on the basis of the looped back second main signal,
or
the first user apparatus or first control apparatus responds with a third main signal to the first main signal transmitted from the second user apparatus or second control apparatus that generates and terminates the main signal in the signal format selected on the basis of the signal format used by the opposing second user apparatus or second control apparatus,
the second user apparatus or second control apparatus determines whether a signal path including sections between the second user apparatus or second control apparatus and the first user apparatus or first control apparatus is normal on the basis of the third main signal used in the response,
or
the first user apparatus or first control apparatus responds with a fourth main signal to the second main signal transmitted from the second user apparatus or second control apparatus in the signal format selected on the basis of the signal format used by the opposing second user apparatus or second control apparatus, and
the second user apparatus or second control apparatus determines whether a signal path including sections between the second user apparatus or second control apparatus and the first user apparatus or first control apparatus is normal on the basis of the fourth main signal used in the response.

4. The communication system according to claim 1, wherein the second user apparatus also determines whether the inside of the second user apparatus is normal by using a predetermined signal in the second user apparatus, in addition to determining whether the signal path is normal.

5. The communication system according to claim 1, wherein, when the second user apparatus does not transmit a control signal or main signal indicating a signal for measuring an error rate to the second control apparatus, the second control apparatus transmits a control signal or main signal indicating a signal for measuring an error rate to the second user apparatus, and determines whether the signal path is normal further on the basis of a measurement result of the error rate based on the control signal or main signal looped back by the second user apparatus,
or
when the second user apparatus transmits a control signal or main signal indicating a signal for measuring an error rate to the second control apparatus, the second control apparatus determines whether the signal path is normal further on the basis of a measurement result of the error rate based on the control signal or main signal transmitted from the second user apparatus.

6. The communication system according to claim 1, wherein the second control apparatus transmits a control signal, to which the error correction code is assigned, to the second user apparatus, and determines whether the signal path is normal further on the basis of whether predetermined processing is performed on the control signal looped back from the second user apparatus.

7. A normality determination method executed by a communication system comprising one or more control apparatuses and one or more user apparatuses, the normality determination method comprising:
a first user apparatus or first control apparatus responds with a second control signal to a first control signal transmitted from a second user apparatus or second control apparatus,
the second user apparatus or second control apparatus determines whether a signal path including sections between the first user apparatus or first control apparatus and the second user apparatus or second control apparatus is normal on the basis of the second control signal used in the response,
or
the first user apparatus or first control apparatus loops back the first control signal transmitted from the second user apparatus or second control apparatus, and
the second user apparatus or the second control apparatus determines whether the signal path including the section between the first user apparatus or first control apparatus and the second user apparatus or second control apparatus is normal on the basis of the looped back first control signal.

8. (canceled)

9. (canceled)

10. The communication system according to claim 3, wherein the second user apparatus also determines whether the inside of the second user apparatus is normal by using a predetermined signal in the second user apparatus, in addition to determining whether the signal path is normal.

11. The communication system according to claim 3, wherein, when the second user apparatus does not transmit a control signal or main signal indicating a signal for measuring an error rate to the second control apparatus, the second control apparatus transmits a control signal or main signal indicating the signal for measuring an error rate to the second user apparatus, and determines whether the signal path is normal further on the basis of a measurement result of the error rate based on the control signal or main signal looped back by the second user apparatus,
or
when the second user apparatus transmits a control signal or main signal indicating a signal for measuring an error rate to the second control apparatus, the second control apparatus determines whether the signal path is normal further on the basis of a measurement result of the error rate based on the control signal or main signal transmitted from the second user apparatus.

12. The communication system according to claim 3, wherein the second control apparatus transmits a control signal, to which the error correction code is assigned, to the second user apparatus, and determines whether the signal path is normal further on the basis of whether predetermined processing is performed on the control signal looped back from the second user apparatus.
